(19) United States
(12) Patent Application Publication
(10) Pub. No.: US 2026/0064432 A1
(43) Pub. Date: Mar. 5, 2026

(54) SYSTEM AND METHOD FOR ISOLATED EXECUTION OF SOFTWARE-AS-A-MEDICAL-DEVICE APPLICATIONS ON EDGE-ARTIFICIAL INTELLIGENCE (AI) PLATFORMS

(71) Applicant: NVIDIA Corporation, Santa Clara, CA (US)

(72) Inventors: Soham Sinha, Santa Clara, CA (US); Mahdi Azizian, San Jose, CA (US)

(21) Appl. No.: 18/824,658

(22) Filed: Sep. 4, 2024

(51) Int. Cl. G06F 9/445; G06F 21/12

(52) U.S. Cl. CPC G06F 9/445; G06F 21/12

(57) ABSTRACT

Apparatuses, systems, and techniques providing isolated execution of software-as-a-medical device (SaMD) applications on edge-AI platforms are provided. A criticality level of an application of a plurality of applications associated with a medical device is identified. Based on the criticality level, the application is determined to be executed in one of a plurality of environment. Each environment of the plurality of environments provides a corresponding level of isolation from other applications of the plurality of applications. One or more computing resources are assigned to the application, based at least on the criticality level or resource requirements of the application.

### TECHNICAL FIELD

At least one embodiment pertains to a system and method for isolated execution of software-as-a-medical-device (SaMD) applications on edge artificial intelligence (AI) platforms. For example, at least one embodiment pertains to a mechanism to execute at least two types of SaMD applications on an edge-AI platform, providing corresponding levels of isolation for the at least two types of applications to provide a secure environment.

### BACKGROUND

Software-as-a-Medical-Device (SaMD) applications are software applications that can be used for medical purposes, without being part of a hardware medical device. These applications are designed to perform various functions, including diagnosing conditions, providing treatment recommendations, or monitoring patient data. SaMD can range from mobile apps that track and analyze health metrics to more complex software used in clinical settings to assist in decision-making. Regulatory bodies have established frameworks to ensure the safety, efficacy, and quality of SaMD products, given their critical role in healthcare. The growing adoption of SaMD reflects the increasing integration of digital technology into healthcare, offering innovative solutions to improve patient outcomes, enhance the efficiency of healthcare delivery, and provide personalized care.

### BRIEF DESCRIPTION OF DRAWINGS

FIG. 1 is a block diagram of an example architecture of a computing system, according to at least one embodiment.

FIG. 2 is a flow diagram of an example method of implementing a SaMD system design for edge platforms, according to at least one embodiment.

FIG. 3 is an example system design for applications running on an edge-AI platform, according to at least one embodiment.

FIG. 4 is an example system design for applications running on an edge-AI platform, according to at least one embodiment.

FIG. 5 is an example system design employing a type-1 hypervisor for an edge-AI platform, according to at least one embodiment.

FIG. 6 is an example use-case SaMD system design for an edge-AI platform, according to at least one embodiment.

FIG. 7 is an example use-case SaMD system design for an edge-AI platform, according to at least one embodiment.

FIG. 8 is an example use-case SaMD system design for an edge-AI platform, according to at least one embodiment.

FIG. 9 is an example use-case SaMD system design for an edge-AI platform, according to at least one embodiment.

FIG. 10A illustrates inference and/or training logic, according to at least one embodiment.

FIG. 10B illustrates inference and/or training logic, according to at least one embodiment.

FIG. 11 illustrates training and deployment of a neural network, according to at least one embodiment.

FIG. 12 illustrates an example data center system, according to at least one embodiment.

FIG. 13 is a block diagram illustrating a computer system, according to at least one embodiment.

FIG. 14 is a block diagram illustrating a computer system, according to at least one embodiment.

FIG. 15 illustrates a computer system, according to at least one embodiment.

FIG. 16A illustrates a computer system, according to at least one embodiment.

FIG. 16B illustrates a computer system, according to at least one embodiment.

FIG. 16C illustrates a computer system, according to at least one embodiment.

FIG. 16D illustrates a computer system, according to at least one embodiment.

FIGS. 16E and 16F illustrate a shared programming model, according to at least one embodiment.

### DETAILED DESCRIPTION

Software-as-a-Medical-Device (SaMD) applications are software that are used for medical purposes but that are not associated with a particular medical hardware device. SaMD applications can be used for a variety of functions, such as diagnosing, monitoring, and/or treating medical conditions, as well as note-taking, summary-generating, and/or music-playing functions. Some SaMD applications can implement artificial intelligence (AI) to provide enhanced functionality. For instance, AI in SaMD can be used to identify patterns in medical images, predict disease progression, or tailor personalized treatment plans based on a patient's unique health profile.

SaMD applications can be categorized according to criticality levels. Class I refers to the lowest critical level, and covers non-serious situations. Class I SaMD applications include applications that may provide information without directly affecting a treatment. Examples of Class I SaMD include wellness apps, symptom checkers, and so on. Class II SaMD is the mid-range critical level, and applies to software having moderate risk used in serious healthcare situations where the software does not directly diagnose or treat a patient, but merely informs clinical decisions. Errors in Class II SaMD may result in significant but not immediately life-threatening impact. Examples of Class II SaMD include decision-support tools for chronic conditions. Class III SaMD applications are extremely patient-sensitive and are used in critical situations in which the SaMD drives clinical management, treatment and/or diagnosis. Examples of Class III SaMD include cardiac pacemakers, deep brain stimulation electrodes, etc. SaMD applications can also be categorized as non-device applications, which include applications that are not developed for medical purposes but that can execute on a medical device (an example of a non-device application is a music-listening app).

Because SaMD applications can have a direct impact on patient health, they are subject to regulation by healthcare authorities, such as the US Food and Drug Administration (FDA). Some SaMD applications can undergo rigorous validation and testing to ensure accuracy, reliability, and safety. Thus, developers of SaMD applications often navigate complex regulatory landscapes to ensure their software meets all necessary requirements. For example, a developer of a SaMD application is responsible for ensuring that a failure or bug in their application will not put the patient at harm. As another example, a SaMD application that implements AI may risk using a significant amount of computational and/or data resources, which can negatively affect the SaMD application and potentially put the patient at harm. In the current environment, the developer of SaMD applications implementing AI is responsible for ensuring that the applications will not overconsume resources. This level of responsibility can hinder development and distribution of SaMD applications. Thus, there is a need for a system design for deploying SaMD applications of various criticality on a single compute platform, that ensures appropriate isolation between SaMD applications based at least on criticality levels, and provisions CPU and GPU resources to leverage artificial intelligent and/or machine learning workloads.

Aspects of the present disclosure address the above-noted and other deficiencies by providing a mechanism to achieve different levels of isolation for SaMD applications on a device such as an edge-AI platform. An edge-AI platform can provide AI computing capabilities, enabling real-time (or near-real time) data processing and decision-making in environments with potentially limited connectivity or where low latency may be critical (e.g., a medical environment). In a medical environment, for example, SaMD applications can leverage edge-AI platforms to reduce latency in data processing and decision-making at the point of care. For example, SaMD applications for a surgical medical device can leverage an edge-AI platform to enable near real-time analysis with minimal latency. The edge-AI platform can support both AI applications or services, and non-AI applications or services. An application can be described as a software program that is designed to perform specific tasks for an end-user, while a service can be described as a background process that can run continuously without direct user interaction. References to applications throughout the disclosure include services.

In at least one embodiment, the present disclosure implements a system design to co-host at least Class I software-as-a-medical-device (SaMD) applications, Class II SaMD applications, and non-device applications on a single compute platform. Class I refers to the lowest criticality level for SaMD applications, and Class II refers to the mid-range criticality level for SaMD applications. Non-device applications are applications that are not developed for medical purposes but that can execute on a medical device (an example of a non-device application is a music-listening application). In embodiments, non-device applications may be developed by third parties. Non-device applications may not have gone through regulatory review. Such non-device applications may be separated from device SaMD applications in embodiments to ensure that the non-device applications do not interfere with the device SaMD applications.

In at least one embodiment, the system design provides multiple execution environments for deploying SaMD applications on an edge-AI compute platform or other devices. Each execution environment can provide a varying degree of isolation from other applications executing on the same compute platform. In at least one embodiment, the system design provides three execution environments. The first execution environment can execute applications in “bare metal” on the operating system (OS). The execution second environment can deploy SaMD applications using containers, which provide partial isolation from the rest of the system. The third execution environment can deploy SaMD applications using virtual machines (VMs) that have full isolation from the rest of the system. Applications can be executed in one of the execution environments based on the criticality level of the application. As an example, non-device applications can be assigned to the third execution environment, to provide full isolation from the other applications. Thus, if the non-device application fails or otherwise creates a hostile execution environment, the other applications will not be affected. Class I and/or Class II criticality level SaMD applications may be executed in the first and/or second execution environments. In some embodiments, Class I and/or Class II criticality level SaMD applications may be executed in the third execution environment.

The system design can implement a design configuration (e.g., provided by the device manufacturer) that identifies which environment is to be used for which applications. For example, a configuration can identify native applications to run in the first environment (e.g., bare metal on the OS), Class I and Class II applications to run in the second environment (e.g., in containers), and non-device applications to run in the third environment (e.g., in virtual machines). A native application is an application that is designed and/or optimized to run on the edge-AI device's hardware and OS. A native application may be considered a Class I or a Class II application in embodiments. In some embodiments, a default configuration can be implemented, in which native, Class I and Class II applications are executed in containers, and non-device applications are deployed in virtual machines.

In some embodiments, computing resources can be allocated and/or provisioned based at least on the execution environment. In some embodiments, computing resources can be allocated and/or provisioned to the applications based on criticality level and resource requirements of the applications. In some embodiments, a provisioning layer can arbitrate GPU and/or CPU resources between the applications. The provisioning can be specific to the device manufacturer. For example, the original equipment manufacturer or the original design manufacturer can configure the resource provisioning. In some embodiments, a default resource provisioning can be implemented, in which resources are assigned to the Class II applications first (e.g., the applications with the highest criticality levels), to the Class I applications second, and then to the non-device applications last. If there are not sufficient resources remaining for the non-device applications after assigning resources to the Class II and Class I applications, the remaining resources can be divided between the non-device applications.

The resources provisioned can include central processing unit (CPU) resources, memory resources and/or graphics process unit (GPU) resources, for example. The GPU resources can include an integrated GPU (iGPU) and/or one or more discrete GPUs (dGPUs). In at least one embodiment, the GPU resources can be split into multiple GPU resources, e.g., as multi-instance GPUs (MIGs). Provisioning resources may include implementing a multi-process service (MPS) that allows multiple applications or processes to share a single GPU. Provisioning may provide applications exclusive access to a streaming multiprocessor (SM) of a GPU (or MIG) to enable parallel computations within a GPU. Providing applications with exclusive access to SMs can help ensure that the applications do not interfere with each other.

The systems and methods described herein may be used for a variety of purposes, by way of example and without limitation, for medical imaging and diagnostics, predictive analytics and risk assessment, virtual health assistants and chatbots, robotic surgery, administrative workflow automation, machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

The systems and techniques disclosed herein are particularly advantageous for medical devices to implement various applications of varying levels of criticality in differing levels of isolation. By providing varying levels of isolation, third-party non-device applications can run concurrently with highly critical SaMD applications on a device, without putting a patient at risk of harm. That is, the failure of a non-device application, running in complete isolation on a VM, is unlikely to affect the performance of a SaMD application critical to the patient safety. Furthermore, the resource provisioning performed based on the criticality level can help ensure that higher critical SaMD applications have sufficient resources to execute uninterrupted, even when lesser critical applications are executing concurrently on the device. The disclosed embodiments provide an enhanced performance and security of SaMD applications concurrently running on a device.

Disclosed embodiments may be comprised in a variety of different systems such as automotive systems (e.g., a control system for an autonomous or semi-autonomous machine, a perception system for an autonomous or semi-autonomous machine, an in-vehicle infotainment system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems for generating or presenting at least one of augmented reality content, virtual reality content, mixed reality content, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implementing one or more language models, such as large language models (LLMs), small language models (SLMs), or vision language models (VLMs) that may process text, voice, image, and/or other data types to generate outputs in one or more formats, systems implemented at least partially using cloud computing resources, systems for performing generative AI operations, and/or other types of systems.

### System Architecture

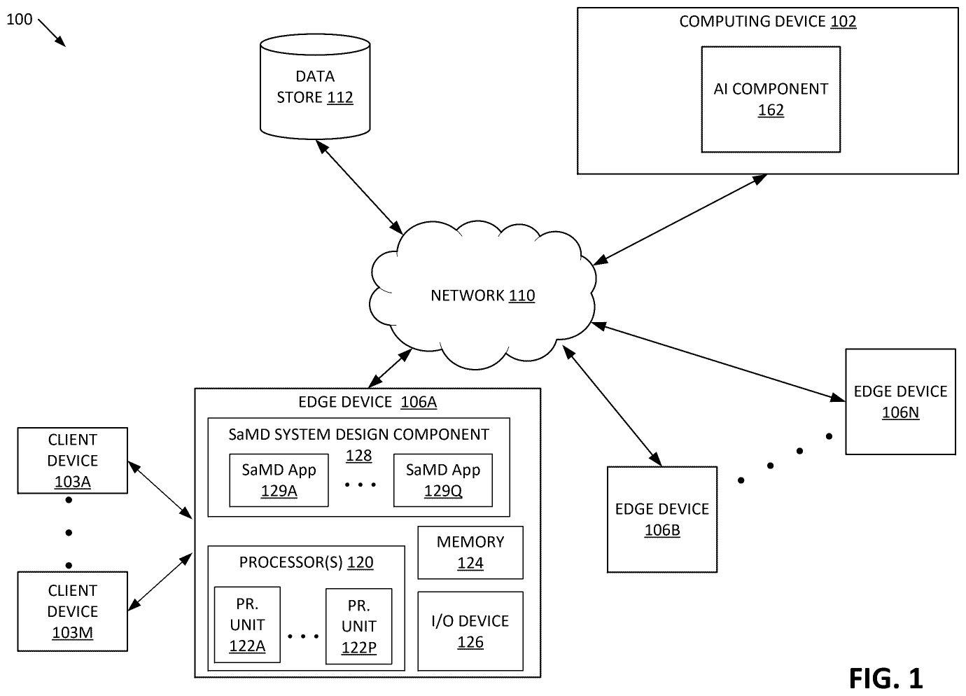

FIG. 1 is a block diagram of an example architecture of a computing system 100, according to at least one embodiment. The system architecture 100 (also referred to as “system” herein) can include a computing device 102, one or more edge devices 106A-N (collectively and individually referred to as edge device 106 herein), and/or one or more data stores 112 (collectively and individually referred to as data store 112 herein), each connected by network 110. Each edge device 106 can be connected to one or more client devices 103A-M (collectively and individually referred to as client device 103 herein), e.g., via another network (not shown). It should be noted that system 100 can additionally or alternatively include other components (e.g., one or more server machines, etc.) connected to computing device 102, edge device 106, data store 112, client device 103, etc. via network 110. In implementations, network 110 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some embodiments, data store 112 is a persistent storage that is capable of storing data as well as data structures to tag, organize, and index the data. Data store 112 can be hosted by one or more storage devices, such as main memory, magnetic or optical storage based disks, tapes or hard drives, NAS, SAN, and so forth. In some implementations, data store 112 can be a network-attached file server, while in other embodiments data store 112 can be some other type of persistent storage such as an object-oriented database, a relational database, and so forth, that may be hosted by computing device 102 or one or more different machines coupled to the computing device 102 via network 110.

Computing device 102 may be a desktop computer, a laptop computer, a smartphone, a tablet computer, a server, or any suitable computing device capable of performing the techniques described herein. In some embodiments, computing device 102 may be a computing device of a cloud computing platform. For example, computing device 102 may be, or may be a component of, a server machine of a cloud computing platform. As another example, computing device 102 may be, or maybe a component of, a data center.

Computing device 102 can implement an AI component 162 that develops, trains or updates, deploys, and optionally retrains AI and/or ML models. AI component 162 can train and deploy multiple AI models (including ML models) that correspond to one or more SaMD applications 129A-Q running on edge device 106. References to SaMD applications 129A-Q can include both SaMD applications and services running on edge device 106. As an illustrative example, the AI component 162 can use machine learning to train or update a computing system using training data (e.g., sounds, images, actions, face expressions, texts, and/or other data) to identify patterns in the data that may facilitate data classification, such as the presence of a particular type of an object within a training image or a particular word within a training speech or text. The training data can be stored on data store 112. Training can be supervised or unsupervised. Machine learning models can use various computational algorithms, such as decision tree algorithms (or other rule-based algorithms), artificial neural networks, and the like. The AI component 162 can deploy the successfully trained AI model(s) and/or ML model(s) to an edge device 106, to be used by a SaMD application 129A-Q. Thus, the SaMD application 129A-Q can implement the inference stage, by inputting new data (e.g., received from client device 103A-M) into the trained AI or ML model, and various target objects, sounds, sentences, actions, an/or any other target patterns can be identified using patterns and features learned during training, as an example. In some embodiments, the AI component 162 can train and deploy generative AI models. In some embodiments, data from client devices 103A-M and/or the output of the inference-based service of a SaMD application 129A-Q can be sent back to AI component 162, e.g., to retrain the AI model. Computing device 102 can retrain the AI model, and send a the retrained AI model to the edge device 160. Edge device 106 can update the corresponding SaMD application 129A-Q with the updated retrained AI model.

Client device 103 can be any computing device that enables users to access features of an application. For example, client device 103 may be, or may be a component of, devices such as, but not limited to: medical devices, Internet of Things (IoT) devices, televisions, smart phones, cellular telephones, personal digital assistants (PDAs), portable media players, netbooks, laptop computers, electronic book readers, tablet computers, desktop computers, set-top boxes, gaming consoles, autonomous vehicles, surveillance devices, and the like. In an illustrative example, client devices can be medical IoT devices in a medical setting (e.g., in a hospital, in an operating room, in a doctor's office, etc.). Client device 103 can collect data and send the data to edge device 106.

An edge device 106 can refer to a computing device that operates at the boundary of a network. An edge device 106 may process data at the edge of a network, close to where the data is generated, rather than sending the data to a centralized cloud or data center for processing. Edge devices may reduce latency, bandwidth usage, and responsive times by performing computation and analysis locally. Edge devices have computing power to analyze, filter, and cat on data locally. Edge devices may connect to other local devices, sensors, and/or other computing device for additional processing or storage, but can operate independently without such connections. An edge device 106 may enable communication between computing devices at the boundary (e.g., interface) between two networks in some embodiments. One example of an edge device is Nvidia's IGX™, which is an industrial-grade, edge AI platform that combines enterprise-level hardware, software, and support. It can be purpose-built for industrial and medical environments, delivering powerful AI compute, high-bandwidth sensor processing, enterprise security, and functional safety.

As illustrated in FIG. 1, edge device 106A can be connected to data store 112, computing device 102, and/or other edge devices 106B-N, via network 110, and can be connected to one or more client devices 103 (e.g., either directly or via another network). In some embodiments, edge device 106 can be connected to client devices 103 via network 110. In some embodiments, edge device 106 can include one or more hardware components. In some embodiments, an edge device 106 may not be connected to other devices (e.g., such as if the edge device loses network connectivity). In such instances, the edge device 106 may continue to run applications such as SaMD applications executing thereon without interruption.

As illustrated in FIG. 1, edge device 106A can include one or more processors 120 (collectively and individually referred to as processor 120 herein), a memory 124, one or more input/output (IO) devices 126, and/or other components. Processor 120 can include one or more processing units 122. A processing unit refers to a component that performs logical and/or arithmetical operations on data. In some embodiments, processing units 122 can include one or more central processing units (CPUs) and/or one or more graphical processing units (GPUs). Other types of processing units that may be included in edge device 106 are, but not limited to, a data processing unit (DPU), tensor processing unit (TPU), neural processing unit (NPU), vision processing unit (VPU), accelerated processing unit (APU), and floating point unit (FPU). A GPU can include any processing unit that is specially designed to accelerate graphics rendering (e.g., for SaMD applications 129A-Q running via client device 103). A DPU offloads data-centric tasks from a CPU, such as for networking, data processing, and storage management. A TPU is a type of artificial intelligence (AI) accelerator that is optimized to perform tensor operations. An NPU is a dedicated processing unit for accelerating neural network computations. A VPU is a processing unit optimized for image and video processing. An APU combined CPU and GPU capabilities on a single chip to provide efficient processing for both general and graphical tasks. An FPU is a processing unit optimized to handle complex arithmetic calculations such as floating point operations.

As illustrated in FIG. 1, processor 120 can include multiple processing units. In some embodiments, processor 120 can be or can otherwise correspond to a multi-core processor. A multi-core processor refers to a processor on a single integrated circuit with two or more separate processing units. Each processing unit of a multi-core processor can read and execute instructions, as described herein. It should be noted that although some embodiments describe processor 120 as a multi-core processor, embodiments of the present disclosure can be applied to any type of computer architecture.

In some embodiments, each physical processing unit 122 of processor 120 can be associated with a logical processing unit. A logical processing unit can be defined as a logical partition of a physical processing unit 122 so as to support parallel processing by the physical processing unit 122. A logical processing unit can include a virtual construct of an operating system (OS) of edge device 106 for managing and scheduling tasks on physical processing units 122. In some instances, a logical processing unit is also referred to as a thread (e.g., thread of execution).

Memory 124 can include one or memory devices (not shown) that can store data and/or instructions that is accessible to processor 120 (e.g., via a bus, etc.). In some embodiments, memory 124 can include volatile memory devices and/or non-volatile memory devices. For example, memory 124 can include or otherwise correspond to a Dynamic Random Access Memory (“DRAM”) device, a Static Random Access Memory (“SRAM”) device, a flash memory device, or another memory device. I/O device 126 can include any device that enables the transfer of data between one or more components of edge device 106 (e.g., processor 120, memory 124, etc.) and/or between component(s) of edge device 106 and other component of system 100. For example, I/O device 126 can include a network interface card (NIC), an audio/visual device (e.g., a monitor, speakers, etc.), a storage device, a keyboard, a mouse, and so forth.

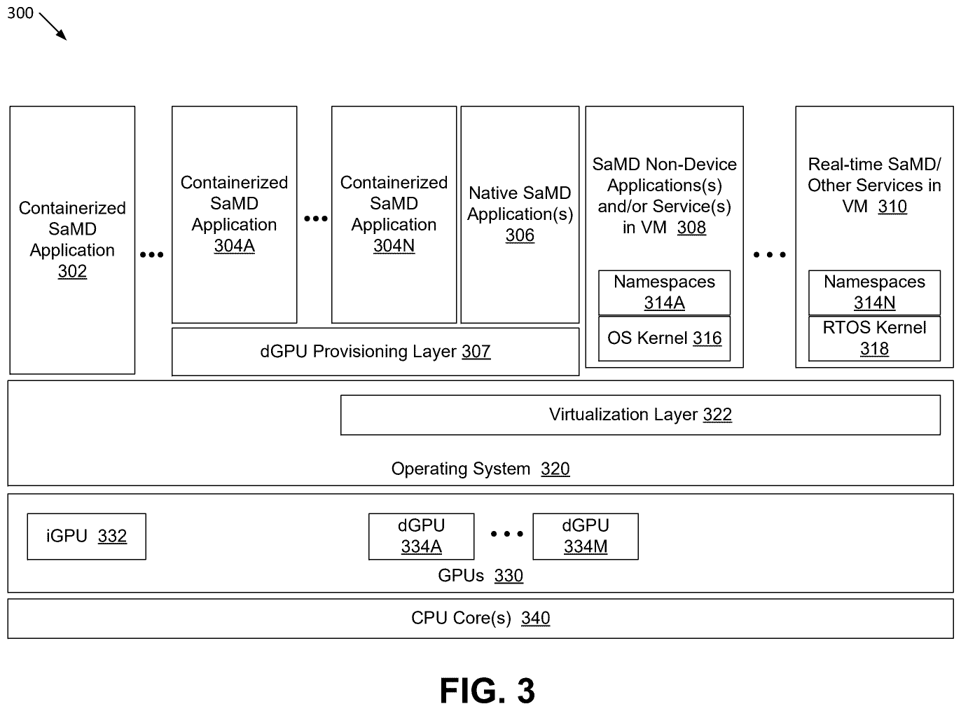

Edge device 106 can also include a SaMD system design component 128. It should be noted that in some embodiments, SaMD system design component 128 can be executed by computing device 102, client device 103, and/or another computing device not shown in FIG. 1. The SaMD system design component 128 can implement a system design and architecture for deploying SaMD applications 129A-Q on edge device 106. Various system design examples are described with respect to FIGS. 3-9. The SaMD system design component 128 provides a mechanism to implement multiple execution environments for SaMD applications 129A-Q, including implementing specific resource provisioning for the SaMD applications 129A-Q. The execution environments (also referred to herein as “environments”) provide varying degrees of isolation for the SaMD applications 129A-Q, providing the secure and safe functioning of the edge device 106. In at least one embodiment, the SaMD system design component 128 can implement a system design according to configurations received from the original equipment manufacturer (OEM) or original design manufacturer (ODM), e.g., of edge device 106. Example system designs are described throughout this disclosure, however other designs not described herein are possible.

In at least one embodiment, the SaMD applications and/or services 129A-Q can include AI or ML applications that receive input data from a client device 103 (e.g., a medical device, sensors, etc.). The system design component 128 can identify a criticality level of the SaMD application 129A-Q. In at least one embodiment, the criticality level can be specified in the metadata of the SaMD application. In at least one embodiment, the SaMD application can be identified using an identification number (or another appropriate identification mechanism), and the SaMD system design component 128 can identify the criticality level that corresponds to the identification number. For example, the data store 112 can store a list of identification numbers and the corresponding criticality level. In at least one embodiment, the criticality level can be communicated to the SaMD system design component 128, e.g., during download and/or installation of the SaMD application.

The SaMD system design component 128 can determine in which environment to deploy and/or execute the SaMD application based on the identified criticality level. The environment can be one of a number of possible environments provided by the SaMD system design. The possible environments can include executing the SaMD application on bare metal directly on an operation system, executing the SaMD application in a container, or executing the SaMD application in a virtual machine (VM). In one embodiment, executing an SaMD on bare metal refers to running software directly on a computer's hardware without any intermediary layers, such as an operating system or virtualization layer. This approach allows the software to have direct access to the hardware resources, such as the CPU, memory, and storage, without the overhead introduced by additional software layers. In some embodiments, executing an SaMD on bare metal refers to running software on an operating system.

A container is a self-contained environment that includes one or more applications and their dependencies (e.g., libraries and configuration files) needed to run consistently on different computing devices. Containers can share the host's operating system but are isolated from other containers and VMs. A container can be more efficient than a VM in terms of resource usage, but provides a slightly less isolated environment than a VM (since the containers share the host system's OS, for example).

A VM is a software emulation of a physical computer than runs on an OS and one or more applications. A VM runs within a host system, and relies on a hypervisor to allocate resources (e.g., CPU, GPU, memory, and/or storage resources) from the physical host to the virtual environment. A VM can provide the highest isolation from the rest of system, and thus can be used to execute applications that have not been vetted by the medical equipment manufacturer or designer. For example, a music playing application can be executed in a VM. Because VMs provide full isolation from the rest of the system, the performance of an application running in VM should not adversely affect the performance of the other, higher critical applications. Applications that have been vetted by the medical equipment manufacturer (and/or by a governing agency) can be run in a less isolation environment. For example, Class II and Class I applications can run in a container.

In some embodiments, the SaMD system design component 128 can implement a design configuration (e.g., provided by the medical equipment manufacturer) that identifies which application(s) can run in which environment(s).

The SaMD system design component 128 can assign one or more computing resources (e.g., processor 120, memory 124, I/O device 126, and/or other resources) to the SaMD applications 129A-Q. In at least one embodiment, the computing resources can include compute resources, memory resources, storage resources, graphics resource, and/or display resources. The amount of resources provisioned to the SaMD application 129A-Q and/or the priority of resource allocation to the SaMD application can correspond to the criticality level, and/or the resource requirements of the SaMD application 129A-Q. In at least one embodiment, the SaMD system design component 128 can identify the resource requirements of the SaMD application 129A-Q from the metadata of the application itself. In at least one embodiment, the SaMD application can communicate (e.g., request) the resource requirements upon download and/or installation.

In at least one embodiment, the computing resources (or a subset of the computing resources) allocated to a SaMD application 129A-Q can be defined by the environment in which the SaMD application 129A-Q is deployed. For example, in one implementation, a SaMD application 129A-Q that is deployed in a virtual machine may only have access to discrete GPU resources, native applications may only have access to discrete GPU resources, and containerized SaMD applications can have access to both integrated GPU and discrete GPU resources.

In some embodiments, the SaMD system design component 128 can implement a provisioning layer that arbitrates the use of GPU resources among the SaMD applications 129A-Q. The GPU resources can include integrated GPU (iGPU) resources, discrete GPU (dGPU) resources, and/or multi-instance GPU (MIG) resources. The MIG resources can be either iGPU and/or dGPU.

In at least one embodiment, the SaMD system design component 128 can allocate resources to the SaMD applications that have the highest criticality levels first, then allocate resources to the SaMD applications that have the second highest criticality level next, and finally allocate resources to the SaMD applications that have the lowest criticality level last. This can help ensure that the highest criticality applications have sufficient resources to execute uninterrupted.

In at least one embodiment, the SaMD system design component 128 can deploy and/or execute the SaMD application 129A-Q in the identified environment. Multiple SaMD applications 129A-Q can execute concurrently. In at least one embodiment, at least one SaMD application can execute in a first environment (e.g., executing the SaMD application on bare metal or in a container) and a second SaMD application can execute concurrently in a second environment (e.g., executing the application in a virtual machine).

In at least one embodiment, the SaMD system design component 128 can deploy one or more virtual machines to execute one or more SaMD applications or services 129A-Q. The SaMD system design component 128 can implement a virtual network and/or shared communication to enable the VMs to communicate. For example, using a virtual network, the VMs may communicate via a virtual ethernet connection on a hosted bridge network. As another example, the SaMD system design component 128 can implement an inter-VM shared memory (ivshmem) interface that allows VMs to share memory directly, enabling high-speed communication between the VMs.

The SaMD system design component 128 is further described below.

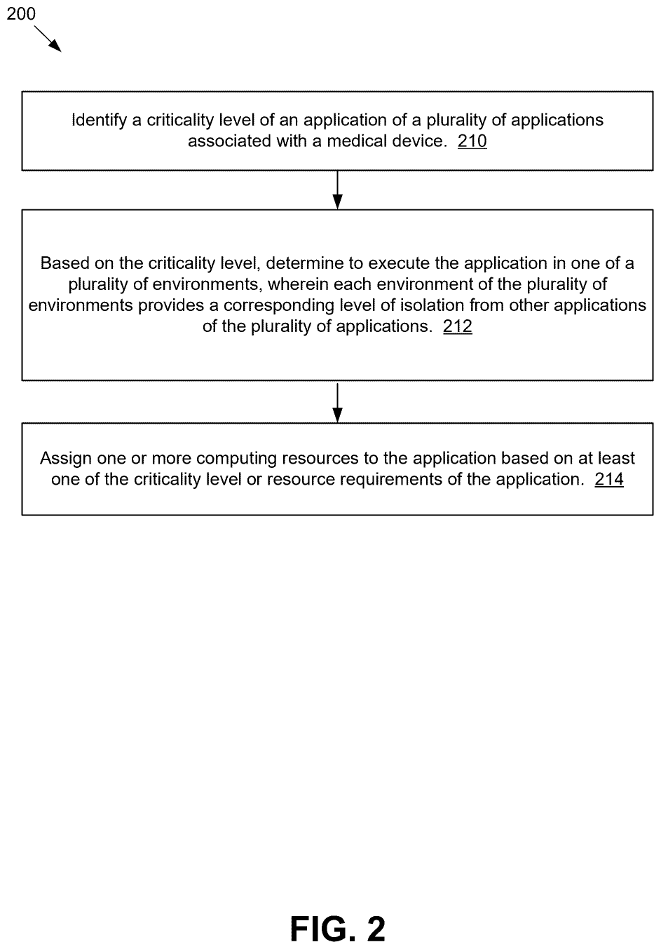

FIG. 2 is a flow diagram of an example method 200 of implementing a SaMD system design for edge platforms, according to at least one embodiment. In at least one embodiments, method 200 may be performed by SaMD system design component 128 of FIG. 1. In at least one embodiment, processing units performing method 200 may be executing instructions stored on a non-transient computer-readable storage media. In at least one embodiment, method 200 may be performed using processing threads (e.g., CPU threads and/or GPU threads), with individual threads executing one or more individual functions, routines, subroutines, or operations of the method. In at least one embodiment, processing thread implementing any of the method 200 may be synchronized (e.g., using semaphores, critical sections, and/or other thread synchronization mechanisms). Alternatively, processing threads implementing any of method 200 may be executed asynchronously with respect to each other. Various operations of method 200 may be performed in a different order compared to the order shown in FIG. 2. Some operations of method 200 may be performed concurrently with other operations. In at least one embodiment, one or more operations show in FIG. 2 may not always be performed.

At block 210, processing logic may identify a criticality level of an application of a plurality of applications associated with a medical device. The plurality of applications can be (or include) SaMD applications or services, and may correspond to SaMD applications 129A-Q of FIG. 1. In at least one embodiment, processing logic can identify a criticality level from metadata of the application or service. In some embodiments, the application metadata can include an application identifier (e.g., the application name, identification number, or a class identifier), and the processing logic can identify the criticality level of the application using a lookup table. The lookup table (e.g., stored in memory 124 of FIG. 1) can list application identifiers and corresponding criticality levels. In some embodiments, the SaMD application can include an executing an AI model. For example, the SaMD application can execute an inference-based service for an AI trained and deployed by another computing device (e.g., computing device 102 of FIG. 1).

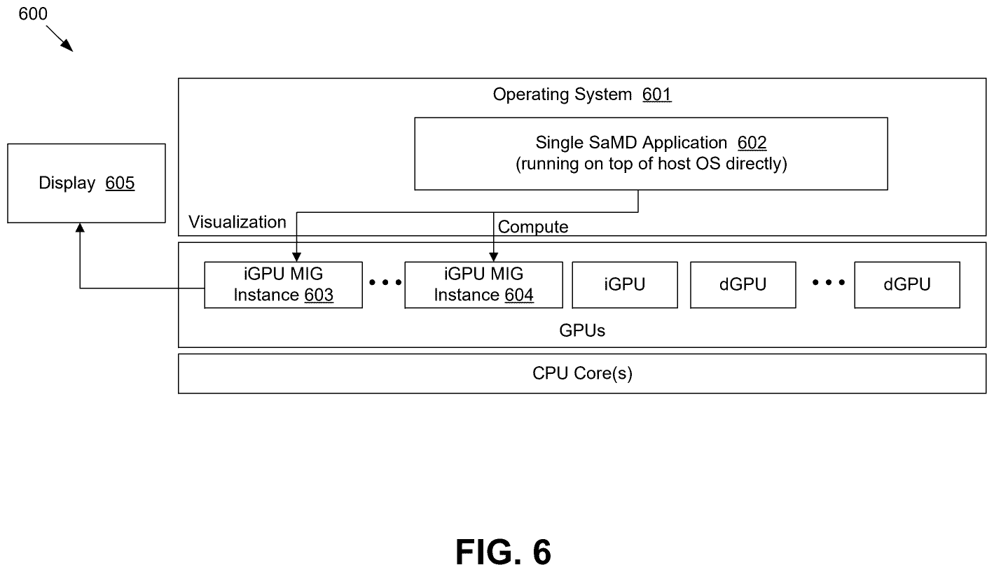

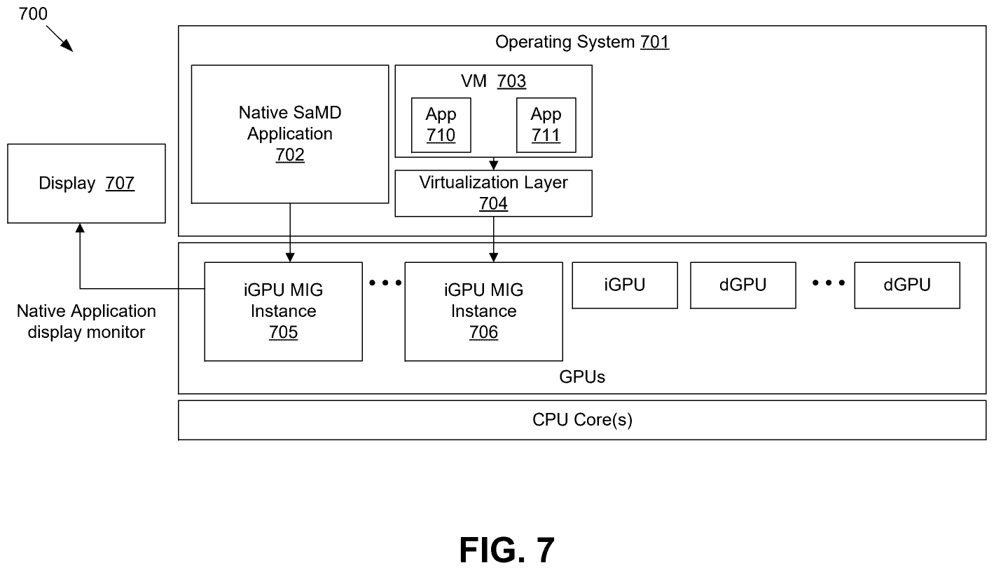

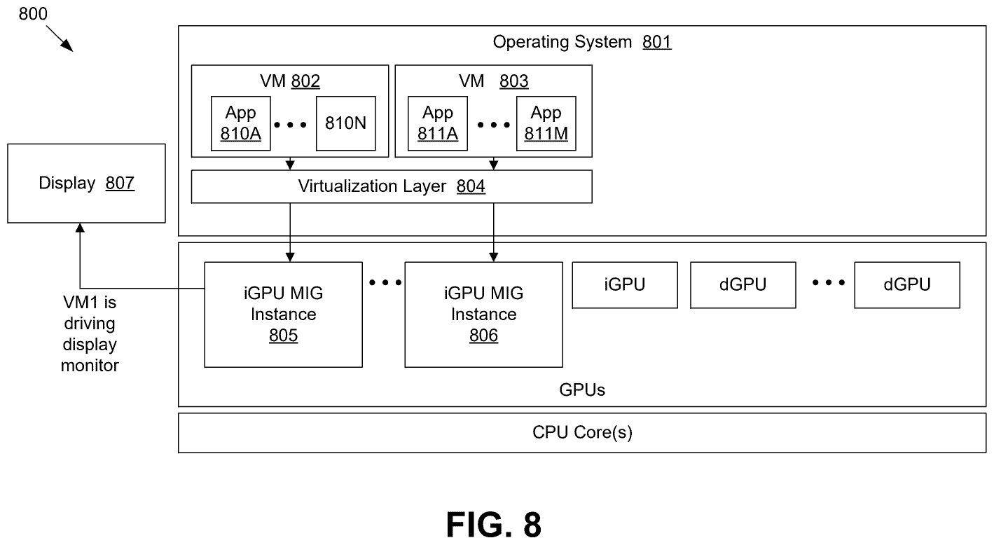

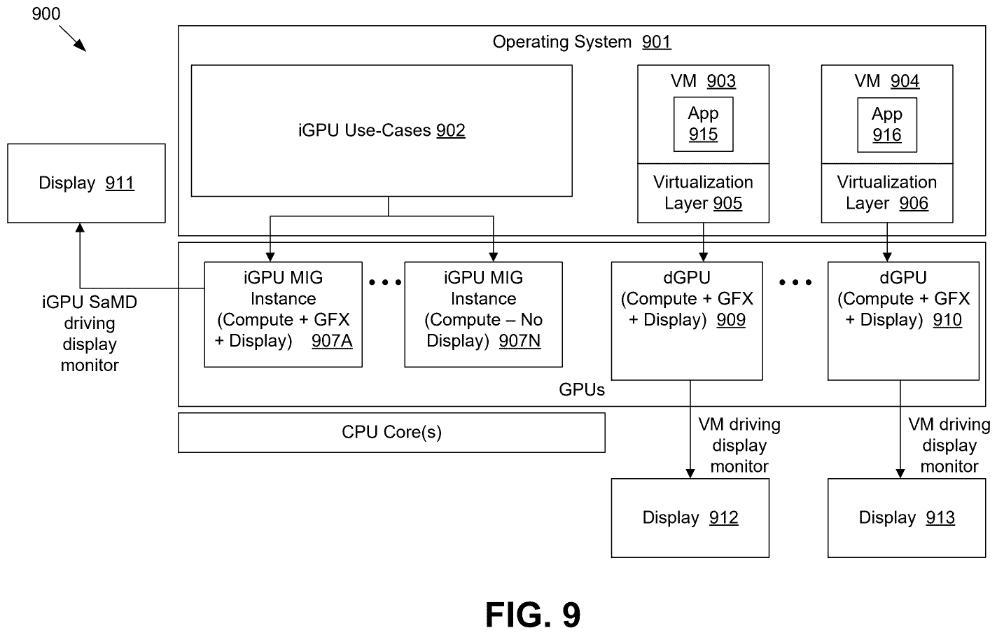

At block 212, processing logic may determine to execute the application in one of a plurality of environments. In some embodiments, processing logic can provide a plurality of environments that each provide a distinct level of operational isolation. The determination can be based on the criticality level. Each environment of the plurality of environments can provide a corresponding level of isolation from other applications of the plurality of applications. In some embodiments, a first environment of the plurality of environments can include executing the application directly on the operating system (e.g., executing the application on bare metal). An example of executing an application in the first environment is described with respect to FIG. 6. In some embodiments, a second environment of the plurality of environments can include executing the application in a container. An example of executing an application in the first environment a container is described with respect to FIG. 7. In some embodiments, a third environment of the plurality of environments can include executing the application in a virtual machine. An example of executing an application in a container is described with respect to FIGS. 8-9. The various environments can provide varying degrees of isolation. In some embodiments, the distinct level of operational isolation (e.g., corresponding to an execution environment) can include partial isolation or full isolation. For example, the second environments can provide partial isolation and the third environment can provide full isolation. The first environment can provide very little isolation, and in some embodiments, can be used for native application. Thus, in some embodiments, processing logic can deploy an application within a selected execution environment from the plurality of execution environments based on the criticality level of the application.

At block 214, processing logic may assign, allocate, and/or provision one or more computing resources to the application based on at least one of the criticality level of resource requirements of the application or resource requirements of the application. That is, in some embodiments, processing logic can include identifying the resource requirements of the application, e.g., from the resource metadata of the application. In some embodiments, processing logic may assign, allocate, and/or provision one or more computing resources to the application based at least on the selected execution environment. The resource requirements can include, for example, compute resources, graphics resources, and/or display resources. In some embodiments, the computing resources can include central processing unit (CPU) resources and/or graphics processing unit (GPU) resources. The GPU resources can include multi-instance GPU.

In some embodiments, the application can be a native application. In such cases, processing logic may identify one or more computing resources from a discrete GPU. In some embodiments, in response to determining that the environment satisfies a criterion, the processing logic may include identifying one or more computing resources from an integrated GPU. In some embodiments, the processing logic may identify one or more computing resources from an integrated GPU for environments executing applications in containers and/or in VMs. An example system design for such embodiments is described with respect to FIG. 3.

In some embodiments, in response to determining that the application is a third-party application, processing logic may deploy the application in a virtual machine. In some embodiments, in response to determining that the application is not a third-party application, the processing logic may deploy the application on bare metal or in a container. The application metadata can include an indication of whether the application is a third-party application. For example, the application metadata can include a developer, distributor, or manufacturer identifier, and the processing logic can determine, based on the identifier, whether the application is a third-party application. A third-party application is an application that is developed by an organization that is not the original provider or manufacturer of the edge-AI platform, device, or OS on which it is executing. That is, a third-party application is an application that was created by an external organization, and is not a primary application for the device.

In at least one embodiment, the third-party SaMD applications are executed in VMs, which provide a more secure environment than containers. In some embodiments, the processing logic can leverage quick emulator (QEMU) and kernel-based virtual machine (KVM) on the edge-AI platform to run the VMs. In a least one embodiment, a real-time SaMD service can be deployed from a real-time OS (RTOS) VM. In these embodiments, running the third-party applications in VMs provides full isolation from the primary host applications (which can include Class I and Class II SaMD applications), and thus the third-party applications cannot adversely affect the primary host applications. The errors and exploits in these third-party applications are contained within the VM, providing safety and security to the primary SaMD applications (e.g., the Class I and Class II applications).

In at least one embodiment, non third-party applications (e.g., Class I and Class II SaMD applications) can be afforded additional privileges compared to third-party applications, since Class I and Class II SaMD application have been vetted and curated, e.g., by the original equipment manufacturer (OEM) and/or the original design manufacturer (ODM). For example, non third-party SaMD applications can be executed from inside a Docker container for a known virtualized filesystem and user-space library. In some embodiments, non third-party SaMD applications can be executed as a native Linux process. Non third-party applications can take advantage of GPU resources (e.g., iGPU and/or dGPU) to run AI and/or ML workloads. As an illustrative example, an endoscopy device may have a tool tracking AI or ML service that tags and overlays the endoscopic tools when the camera video is displayed on the screen. Since these SaMD applications can be critical in nature, it is beneficial to have their GPU workloads (e.g., executing AI models) with a certain level of isolation, as is provided by a container.

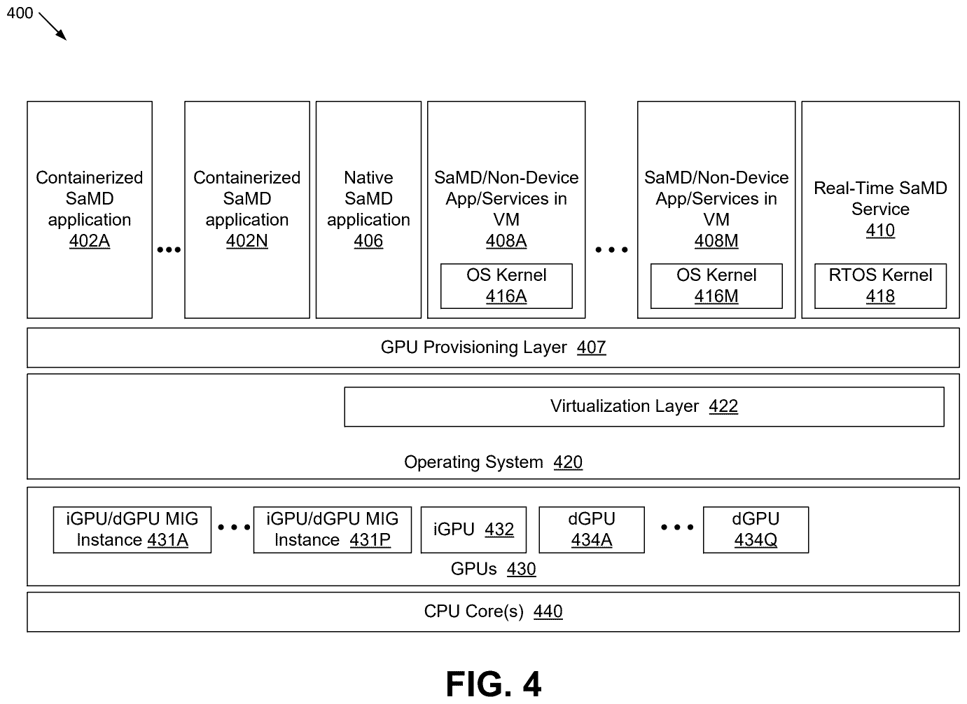

In some embodiments, the plurality of applications can execute concurrently. A first application can execute in a first environment (e.g., on bare metal or in a container), and a second application can execute concurrently in another environment (e.g., in a VM). An example of concurrently running applications in various environments is described with respect to FIGS. 3 and 4, and throughout.

In at least one embodiment, the processing logic can enable a two-pronged approach to facilitate isolation among the concurrently running GPU workloads. The first prong is to enable the iGPU to be used by a single application, running in a container (e.g., a Docker container). The second prong is to enable a GPU provisioning layer to arbitrate dGPU access for all SaMD applications that require dGPU resources (e.g., executing AI and/or ML models). In at least one embodiment, the second prong can enable only Class I and Class II applications to access dGPU resources. In some embodiments, the provisioning can be configured by the OEM and/or ODM. In at least one embodiment, the processing logic can use a compute unified device architecture (CUDA) multi-process service (MPS) to provide SaMD applications with dGPU access, e.g., by providing such applications with exclusive access to SMs so that the performance and execution of the applications do not interfere with each other. The use of SMs can provide more determinism and predictability to the GPU-using applications. In some embodiments, the provisioning layer may also incorporate multi-instance GPUs (MIG).

FIG. 3 depicts an example system design 300 for applications running on an edge-AI platform, according to at least one embodiment. The edge-AI platform can include the CPUs 340 and GPUs 330. In some embodiments, the GPUs 330 can include an integrated GPU 332, and one or more discrete GPUs 334A-M. The iGPU 332 can be built into the CPUs 340, and one or more dGPUs 334A-M can be added to the platform (e.g., via a PCI slot). An operating system 320 can run on the edge AI-platform.

In at least one embodiment, the system design 300 includes SaMD applications 302, 304, and 306 that have access to one or more GPUs 330 (e.g., integrated GPU (iGPU) 332, and/or discrete GPUs (dGPUs) 334A-M). A containerized SaMD application 302 can directly access the iGPU 332. In some embodiments, multiple containerized SaMD applications 304 can directly access the iGPU 332, and a provisioning layer (not shown) can control access to the iGPU by the applications 304.

One or more containerized SaMD applications 304A-N, and/or native SaMD application 306 can have access to the one or more dGPUs 334A-M, e.g., via dGPU provisioning layer 307. A native SaMD application 306 can run on bare metal, without a container. The containerized SaMD application(s) 304 and the native SaMD application(s) 306 can run simultaneously, using the dGPU 334A-M resources.

In at least one embodiment, the dGPU provisioning layer 307 can control the dGPU 334A-M resources allocated to each application 304, 306. In some embodiments, the resource allocation can be determined by the medical device equipment manufacturer. Additionally or alternatively, the resource allocation can depend on criticality of the application and optionally on the resource requirements of the application.

In some embodiments, dGPU provisioning layer 307 can allocate CPU, iGPU, dGPU, multi-instance GPU, and/or SMs. The dGPU provisioning layer 307 can allocate resources to each SaMD application based on criticality (which can be correlate to the risk level of the application), and/or resource requirements. That is, a SaMD application can communicate its resource requirements upon installation or system boot-up, and the SaMD system design component 128 can determine a GPU provisioning configuration to implement. The dGPU provisioning layer 307 can then implement the GPU provisioning determined by the SaMD system design component 128. The GPU provisioning configuration can allocate the resource requirements in full to corresponding SaMD applications, e.g., based on the criticality level. For example, a Class II SaMD application or native application can be allocated its resource requirements in full, a Class I application can be allocated its resource requirements in full assuming there are sufficient resources left to allocate. Otherwise, the Class I application can share resources with the non-device applications or third-party applications.

In some embodiments, containerized application 302, 304A-N, and/or native application 306 can be used for high criticality applications, e.g., Class II applications. While containers may not provide the highest isolation possible, the Class II applications are applications that have been vetted by the medical equipment manufacturer and/or by a governing agency (e.g., the FDA), and thus can be trusted to run in a not fully isolated environment. Additionally, containerized application 302, 304A-N, and/or native application 306 can be applications that require AI workloads to be GPU accelerated. As an illustrative example, containerized application 302 can be a SaMD application that supports a clinical decision, such as an AI algorithm that detects and/or classifies tumors during surgery.

In at least one embodiment, the system design 300 includes third-party applications that do not have access to the one or more GPUs 330. Third-party applications can be applications that are not vetted by medical device manufacturers and/or government agencies, and thus may be less secure that other applications. The third party applications can be deployed in a virtual machine, such as VM 308, 310. As an example, VM 308 can have defined namespaces 314A and can run an OS kernel 316. As another example, VM 310 can have defined namespaces 314N, and can run a real-time OS kernel 318. Deploying third-party applications in such VMs 308, 310 can provide full isolation from the rest of the system, as they have their own namespaces and their own operating systems. Thus, if a SaMD application deployed in a VM 308, 310 fails, the isolation of the VM means that it is unlikely that the failure will affect the rest of the system. In the system design 300, the third-party applications deployed in VMs 308, 310 may not have access to GPU 330 resources. By allocating restricted resources to the third-party applications deployed in VMs 308, 310, the failure of one of these applications is unlikely to affect the resource allocation for the other applications running in the system.

Thus, system design 300 provides three levels of isolation for SaMD applications and services. The first is native applications that run bare metal, the second is containerized applications, and the third (and most isolated) is applications deployed in VMs. A medical device manufacturer can assign SaMD applications to one of the three levels of isolation. For example, the SaMD applications can be assigned to one of the three levels of isolation based on the criticality level. As an illustrative, non-device applications (e.g., applications that are not developed for medical purposes) and/or Class I applications can be deployed in VMs 308, 310, Class I applications that require AI processing can be deployed in a container, while Class II applications can be deployed either in a container or can be bare metal. The system design 300 provides the mechanism for a medical device manufacturer to achieve various levels of isolation, allowing the medical device manufacturer to assess risk profiles and resource requirements and deploy each SaMD application or service in a corresponding environment.

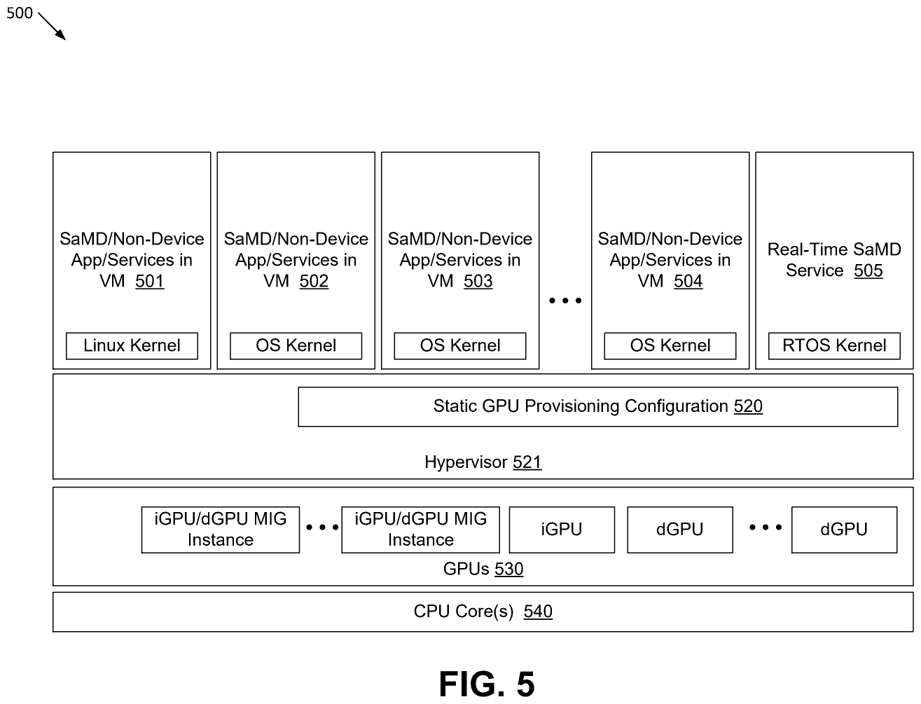

In at least one embodiment, the virtualization layer 322 can manage virtualization of the CPU core(s) 340 and/or GPUs 330 for VMs 308, 310. System design 300 employs a type-2 hypervisor (or hosted hypervisor) for facilitating VMs 308, 310 and GPU virtualization, in which the OS 320 acts as the hypervisor. In alternative embodiments, a type-1 hypervisor (sometimes referred to as a bare-metal hypervisor) may be used. A system design example utilizing a type-1 hypervisor is described with respect to FIG. 5. Employing a type-2 hypervisor may provide enhanced security as compared to a type-1 hypervisor, since a type-1 hypervisor is not configurable at runtime, and thus may not minimize lines-of-code that can reduce the security attack surface.

FIG. 4 depicts an example system design 400 for applications running on an edge-AI platform, according to at least one embodiment. The edge-AI platform can include the CPU core(s) 440 and GPUs 430. In some embodiments, the GPUs 430 can include an integrated GPU 432, one or more discrete GPUs 434A-Q, and multi-instance GPUs (MIGs) 431A-P. The iGPU 432 can be built into the CPU core(s) 440, and one or more dGPUs 434A-M can be added to the platform (e.g., via a PCI slot). In at least one embodiment, all GPU capabilities (e.g., graphics, compute, and/or visualization/display) can be supported simultaneously on all GPUs 430. MIG instances 431A-P can be multiple independent instances of a GPU. Both iGPU 432 and/or dGPU 434A-Q can be partitioned into multiple MIG instances 431A-P. MIG instances 431A-P can be capable of GPU compute, display, and graphics capabilities.

An operating system 420 run on the edge AI-platform. In at least one embodiment, the host OS 420 can act as the hypervisor, through virtualization layer 422, as a type-2 hypervisor. Virtualization layer 422 can support both GPU and CPU virtualization. In at least one embodiment, virtualization layer 422 can support passthrough virtualization, in which an entire GPU of GPUs 430 can be passed trough to a VM 408A-M. Passthrough virtualization can also enable an entire MIG instance 431A-P to be passed through to a VM 408A-M. In at least one embodiment, virtualization layer 422 can assign a MIG instance 431A-P to a VM 408A-M, e.g., by allocating a virtualized instance of MIG 431A-P. Assigning MIG instances 431A-P to a VM 408A-M can enable the partitions of a GPU 432, 434A-Q to be used by different VMs 408A-M. In at least one embodiment, the SaMD system design component 128 can assign a single MIG instance 431A-P to a single VM 408A-M. In another embodiment, the SaMD system design component 128 can enable an iGPU 432, dGPUs 434A-Q and/or a MIG instance 431A-P to be shared between multiple VMs 408A-M, e.g., via vGPU.

In at least one embodiment, the system design 400 can include one or more containerized SaMD applications 402A-N, one or more native SaMD applications 406, one or more SaMD or non-device applications or services deployed in virtual machines 408A-M, and/or one or more real-time SaMD services 410.

Containerized applications 402A-N and/or native application(s) 406, running on a host OS 420, can access iGPU 432, dGPU 434A-Q, and/or MIG instances of GPU 431A-P. GPU provisioning layer 407 can share the GPUs 430 among the containerized applications 402A-N and/or native application(s) 406. In at least one embodiment, the provisioning layer 407 can isolate GPU resources 430 so to facilitate security, safety, and performance of the services. In at least one embodiment, if a GPU of GPUs 430 is allocated to (e.g., being used by) by a containerized application 402A-N and/or a native application 406, that GPU may not be assigned to and shared with any VMs 408A-M, or service 410. Restricting the sharing of GPUs among containerized applications 402A-N and native application(s) 406 with VMs 408A-M, and service 410 can provide safety, security, and performance isolation among the different classes of applications and services.

In at least one embodiment, the GPU provisioning layer 407 can use MPS and/or MIG to provision resources among the SaMD applications and/or services. MPS partitions GPU SMs and memory for compute workloads for containerized application 402A-N and native application(s) 406. For applications running in a VM 408A-M, MPS partitions GPU resources between VM SaMD applications for the GPU which is assigned to the VM. MIG partitions a GPU into MIG instances in the hardware. The GPU provisioning layer 407 can assigned MIG instances 431A-P to containerized applications 402A-N and native application(s) 406. In at least one embodiment, the virtualization layer 422 can virtualize a MIG instance 431A-P (e.g., using vGPU software), and GPU provisioning layer 407 can assign the virtualized MIG instance 431A-P to a VM 408A-M. Thus, a SaMD in a VM 408A-M can access the virtualized MIG instance 431A-P. In at least one embodiment, GPU provisioning layer 407 can provision GPUs 432, 434A-Q between containerized applications 402A-N, native application(s) 406, and/or VM applications 408A-M (e.g., without using MPS or MIG). For example, the provisioning layer 407 can provision the iGPU 432 to native application(s) 406 and/or containerized applications 402A-N. As another example, the provisioning layer 407 can provision an entire dGPU 434A-Q to a SaMD in a VM 408A-M.

System design 400 differs from system design 300 in that in system design 400, a native SaMD application 406 running bare metal on the OS (e.g., without a container) can utilize iGPU resources and/or dGPU resources. Additionally, third-party applications can access GPU resources.

FIG. 5 depicts an example system design 500 employing a type-1 hypervisor for an edge-AI platform, according to at least one embodiment. A type-1 hypervisor enables a similar SaMD system design described with respect to FIGS. 3 and 4, however in system design 500, the hypervisor 521 runs directly on the hardware (e.g., CPUs 540 and GPUs 530), without the need for a base OS. Note that FIG. 5 illustrates a subset of a complete system design, and includes the SaMD applications deployed in VMs 501-505. The system design 500 can be part of a larger system design that also includes native SaMD application(s) and/or containerized SaMD application(s), as illustrated in FIGS. 3 and 4, and described throughout. Each VM 501-505 can run one or more SaMD applications or service. In at least one embodiment, each VM 501-505 can be designed as a SaMD class.

System design 500 differs from system designs 300 and 400 in that in system design 500, the GPU provisioning layer 520 employs a static partitioning manner that is configured at the time of boot-up. Thus, at runtime, the system is not configurable to minimize the lines-of-code in the hypervisor 521, and reduce the security attack surface.

FIG. 6 depicts an example use-case system design 600 for an edge-AI platform, according to at least one embodiment. In this use-case example, a native or containerized SaMD application 602 is running on top of the host OS 601. In this example, the SaMD system design component 128 has allocated two MIG instances 603, 604 that the SaMD application 602 can use as a multi-GPU system. For example, the SaMD application 602 can use the iGPU MIG instance 603 for visualization, and can use the iGPU MIG instance 604 for compute resources. The iGPU MIG instance 603 can include compute, graphics, and display capabilities, while the iGPU MIG instance 604 can include compute and graphics capabilities. In at least one embodiment, the iGPU MIG instance 603 can be connected to a display device 605. This use-case system design 600 can be used to isolate graphics and compute GPU workloads between two separate GPU MIG instances 603, 604. It should be noted that in this example, the GPU resources assigned to the SaMD application 602 can be iGPU MIG instances 603, 604 (as illustrated in FIG. 6), dPGU MIG instances, full iGPU, and/or full dGPU resources.

FIG. 7 depicts an example use-case system design 700 for an edge-AI platform, according to at least one embodiment. In this use-case example, a native or containerized SaMD application 702 is running on top of the host OS 701. The SaMD application 702 has exclusive use of the iGPU MIG instance 705. The iGPU instance 705 can include compute, graphics, and display capabilities. The iGPU MIG instance 705 can drive the display monitor 707.

AVM 703 can run on the host OS 701, supported by type-2 virtualization layer 704. The iGPU MIG instance 706 can be passed through to the VM 703. The iGPU MIG instance 706 can include compute capabilities only. The VM 703 can have exclusive use of the iGPU MIG instance 706. One or more SaMD applications (or services) 710, 711 can run on VM 703, using iGPU MIG instance 706. The VM 703 can act as a secure and isolated sandbox for any third-party applications 710, 711 that may use GPU resources for AI, ML, and/or other accelerated workloads. For example, a SaMD application running on VM 703 can perform inference-based services.

This use-case system design 700 can be used to simultaneously run a native SaMD application 702 and another virtualized SaMD application (including third-party applications) 710, 711 on the edge-AI platform, without affecting each other. Both the native SaMD 702 and the other virtualized SaMD application(s) 710, 711 can execute GPU workloads. A benefit of this system design 700 is that the failure and performance of third-party applications are unlikely to affect the native SaMD application. It should be noted that in this example, the GPU resources assigned to the native SaMD application 702 and/or to the VM 703 can be iGPU MIG instances 705, 706 (as illustrated in FIG. 7), dPGU MIG instances, full iGPU, and/or full dGPU resources.

FIG. 8 depicts an example use-case system design 800 for an edge-AI platform, according to at least one embodiment. In this use-case example, two VMs 802 and 803 run on operating system 801, supported by virtualization layer 804. VM 802 is assigned exclusive use of iGPU MIG instance 805, and VM 803 is assigned exclusive use of iGPU MIG instance 806. It should be noted that in this example, the GPU resources assigned to the VM 802 and/or to VM 803 can be iGPU MIG instances 805, 806 (as illustrated in FIG. 8), dPGU MIG instances, full iGPU, and/or full dGPU resources.

Both VM 802 and VM 803 can be used for difference SaMD applications and/or services. As illustrated, VM 802 can host one or more SaMD applications (or services) 810A-N and VM 803 can host one or more SaMD applications (or services) 811A-M. In at least one embodiment, the VM 802 can host one or more applications 810A-N that may require display resources, and VM 803 can host one or more applications 811A-M that do not require display resources. For example, one or more applications 811A-M can perform an inference-based service. Thus, VM 802 is capable of driving display monitor 807, as well as graphics and compute capabilities, using iGPU MIG instance 805, and VM 803 can be capable of running compute workloads with no display capabilities.

This use-case system design 800 can enable multiple third-party SaMD applications (e.g., 810A-N, 811A-M) to run concurrently on the same computing device (e.g., device 106 of FIG. 1). VMs 802 and 803 provide security and isolation for the third-party SaMD applications running concurrently. VMs 802 and 803 do not share GPU resources, thus enhancing safety, security, and performance of the running applications 810A-N, 811A-M.

FIG. 9 depicts an example use-case system design 900 for an edge-AI platform, according to at least one embodiment. In this use-case example, the edge-AI platform includes multiple dGPUs 909, 910. In at least one embodiment, the iGPU use-cases 902 includes the single SaMD application 602 as described with respect to FIG. 6, the native SaMD application 702 and the VM 703 (including application s710, 711 and virtualization layer 704) as described with respect to FIG. 7, and/or the VMs 802-803 (including applications 810A-N, 811A-M, and virtualization layer 804) as described with respect to FIG. 8. The iGPU use cases 902 can use iGPU MIG instances 907A-N, which can support at least compute capabilities, and in some instances, can support compute, graphics, and display capabilities (and thus can drive display monitor 911), as described with respect to FIGS. 6-8.

VM 903 can run one or more SaMD application (or service) 915, supported by virtualization layer 905. VM 904 can run one or more SaMD application (or service) 916, supported by virtualization layer 906. In at least one embodiment, the VM 903 can utilize the dGPU 909 in passthrough mode. The VM 903 can access all the capabilities of the dGPU 909, including compute, graphics and display capabilities. In some embodiments, the dGPU 910 can be a dGPU MIG instance. VM 904 can access the dGPU MIG instance 910 in passthrough mode, and can access all the capabilities of the dGPU MIG instance 909, including compute, graphics, and display capabilities. As illustrated in FIG. 9, VM 903 can drive display monitor 912, and VM 904 can drive display monitor 913. VMs 903 and 906 can each act as a distinct isolated and secure sandbox, and thus SaMD applications 915, 916 can run concurrently and be isolated from each other, and from other applications running on the edge-AI platform.

### Inference and Training Logic

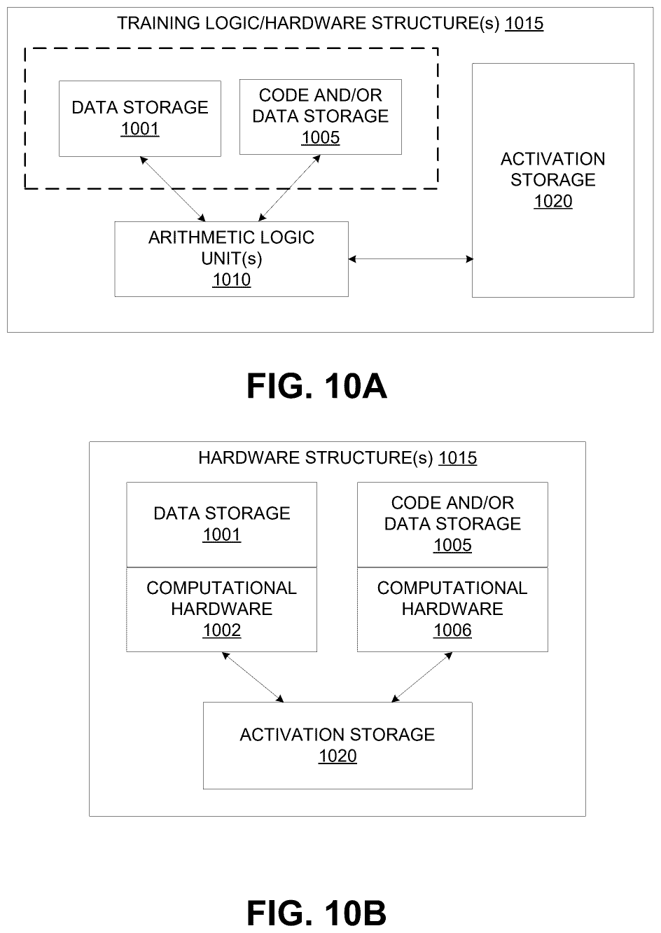

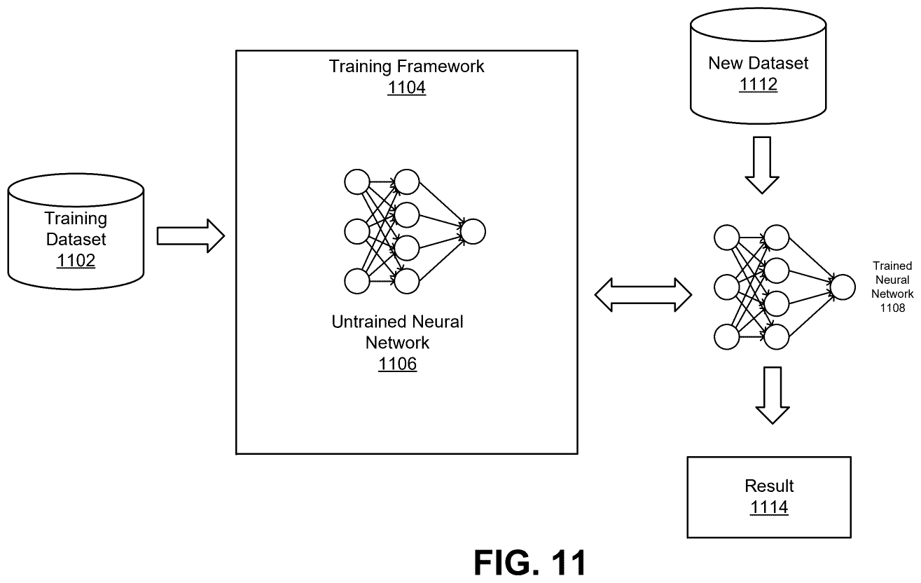

FIG. 10A illustrates inference and/or training logic 1015 used to perform inferencing and/or training operations associated with one or more embodiments. Details regarding inference and/or training logic 1015 are provided below in conjunction with FIGS. 1A and/or 1B.

In at least one embodiment, inference and/or training logic 1015 may include, without limitation, code and/or data storage 1001 to store forward and/or output weight and/or input/output data, and/or other parameters to configure neurons or layers of a neural network trained and/or used for inferencing in aspects of one or more embodiments. In at least one embodiment, training logic 1015 may include, or be coupled to code and/or data storage 1001 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which such code corresponds. In at least one embodiment, code and/or data storage 1001 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 1001 may be included with other on-chip or off-chip data storage, including a processor's L1, L2, or L3 cache or system memory.

In at least one embodiment, any portion of code and/or data storage 1001 may be internal or external to one or more processors or other hardware logic devices or circuits. In at least one embodiment, code and/or code and/or data storage 1001 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 1001 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 1015 may include, without limitation, a code and/or data storage 1005 to store backward and/or output weight and/or input/output data corresponding to neurons or layers of a neural network trained and/or used for inferencing in aspects of one or more embodiments. In at least one embodiment, code and/or data storage 1005 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 1015 may include, or be coupled to code and/or data storage 1005 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 1005 may be included with other on-chip or off-chip data storage, including a processor's L1, L2, or L3 cache or system memory. In at least one embodiment, any portion of code and/or data storage 1005 may be internal or external to one or more processors or other hardware logic devices or circuits. In at least one embodiment, code and/or data storage 1005 may be cache memory, DRAM, SRAM, non-volatile memory (e.g., flash memory), or other storage. In at least one embodiment, a choice of whether code and/or data storage 1005 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 1001 and code and/or data storage 1005 may be separate storage structures. In at least one embodiment, code and/or data storage 1001 and code and/or data storage 1005 may be a combined storage structure. In at least one embodiment, code and/or data storage 1001 and code and/or data storage 1005 may be partially combined and partially separate. In at least one embodiment, any portion of code and/or data storage 1001 and code and/or data storage 1005 may be included with other on-chip or off-chip data storage, including a processor's L1, L2, or L3 cache or system memory.

In at least one embodiment, inference and/or training logic 1015 may include, without limitation, one or more arithmetic logic unit(s) (“ALU(s)”) 1010, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 1020 that are functions of input/output and/or weight parameter data stored in code and/or data storage 1001 and/or code and/or data storage 1005. In at least one embodiment, activations stored in activation storage 1020 are generated according to linear algebraic and or matrix-based mathematics performed by ALU(s) 1010 in response to performing instructions or other code, wherein weight values stored in code and/or data storage 1005 and/or data storage 1001 are used as operands along with other values, such as bias values, gradient information, momentum values, or other parameters or hyperparameters, any or all of which may be stored in code and/or data storage 1005 or code and/or data storage 1001 or another storage on or off-chip.

In at least one embodiment, ALU(s) 1010 are included within one or more processors or other hardware logic devices or circuits, whereas in another embodiment, ALU(s) 1010 may be external to a processor or other hardware logic device or circuit that uses them (e.g., a co-processor). In at least one embodiment, ALUs 1010 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 1001, code and/or data storage 1005, and activation storage 1020 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 1020 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 1020 may be cache memory, DRAM, SRAM, non-volatile memory (e.g., flash memory), or other storage. In at least one embodiment, activation storage 1020 may be completely or partially within or external to one or more processors or other logical circuits. In at least one embodiment, a choice of whether activation storage 1020 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 1015 illustrated in FIG. 10A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 1015 illustrated in FIG. 10A may be used in conjunction with central processing unit (“CPU”) hardware, graphics processing unit (“GPU”) hardware or other hardware, such as field programmable gate arrays (“FPGAs”).

FIG. 10B illustrates inference and/or training logic 1015, according to at least one embodiment. In at least one embodiment, inference and/or training logic 1015 may include, without limitation, hardware logic in which computational resources are dedicated or otherwise exclusively used in conjunction with weight values or other information corresponding to one or more layers of neurons within a neural network. In at least one embodiment, inference and/or training logic 1015 illustrated in FIG. 10B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 1015 illustrated in FIG. 10B may be used in conjunction with central processing unit (CPU) hardware, graphics processing unit (GPU) hardware or other hardware, such as field programmable gate arrays (FPGAs). In at least one embodiment, inference and/or training logic 1015 includes, without limitation, code and/or data storage 1001 and code and/or data storage 1005, which may be used to store code (e.g., graph code), weight values and/or other information, including bias values, gradient information, momentum values, and/or other parameter or hyperparameter information. In at least one embodiment illustrated in FIG. 10B, each of code and/or data storage 1001 and code and/or data storage 1005 is associated with a dedicated computational resource, such as computational hardware 1002 and computational hardware 1006, respectively. In at least one embodiment, each of computational hardware 1002 and computational hardware 1006 comprises one or more ALUs that perform mathematical functions, such as linear algebraic functions, only on information stored in code and/or data storage 1001 and code and/or data storage 1005, respectively, result of which is stored in activation storage 1020.

In at least one embodiment, each of code and/or data storage 1001 and 1005 and corresponding computational hardware 1002 and 1006, respectively, correspond to different layers of a neural network, such that resulting activation from one storage/computational pair 1001/1002 of code and/or data storage 1001 and computational hardware 1002 is provided as an input to a next storage/computational pair 1005/1006 of code and/or data storage 1005 and computational hardware 1006, in order to mirror a conceptual organization of a neural network. In at least one embodiment, each of storage/computational pairs 1001/1002 and 1005/1006 may correspond to more than one neural network layer. In at least one embodiment, additional storage/computation pairs (not shown) subsequent to or in parallel with storage/computation pairs 1001/1002 and 1005/1006 may be included in inference and/or training logic 1015.

### Neural Network Training and Deployment

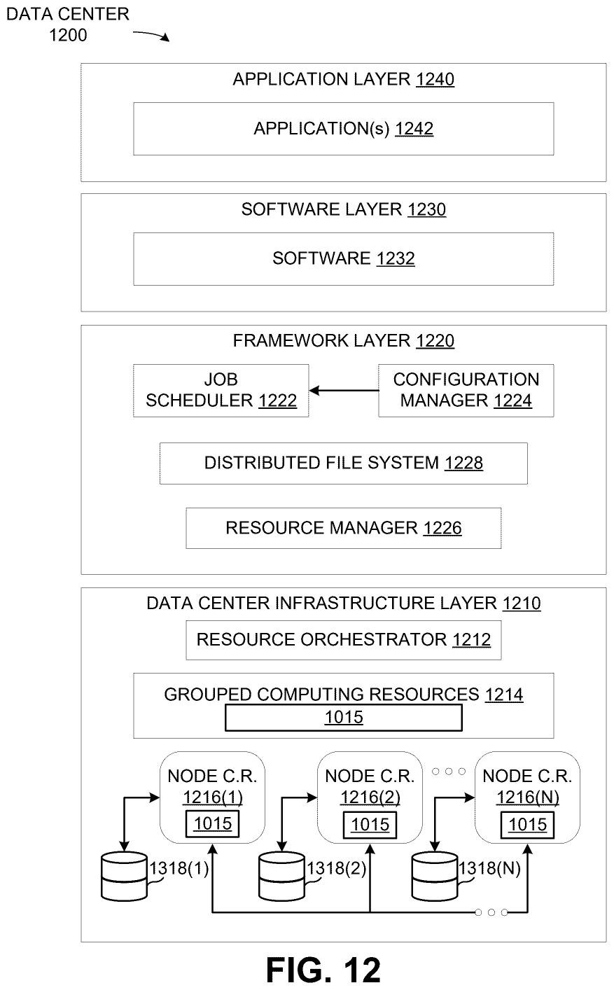

FIG. 11 illustrates training and deployment of a deep neural network, according to at least one embodiment. In at least one embodiment, untrained neural network 1106 is trained using a training dataset 1102. In at least one embodiment, training framework 1104 is a PyTorch framework, whereas in other embodiments, training framework 1104 is a TensorFlow, Boost, Caffe, Microsoft Cognitive Toolkit/CNTK, MXNet, Chainer, Keras, Deeplearning4j, or other training framework. In at least one embodiment, training framework 1104 trains an untrained neural network 1106 and enables it to be trained using processing resources described herein to generate a trained neural network 1108. In at least one embodiment, weights may be chosen randomly or by pre-training using a deep belief network. In at least one embodiment, training may be performed in either a supervised, partially supervised, or unsupervised manner.

In at least one embodiment, untrained neural network 1106 is trained using supervised learning, wherein training dataset 1102 includes an input paired with a desired output for an input, or where training dataset 1102 includes input having a known output and an output of neural network 1106 is manually graded. In at least one embodiment, untrained neural network 1106 is trained in a supervised manner and processes inputs from training dataset 1102 and compares resulting outputs against a set of expected or desired outputs. In at least one embodiment, errors are then propagated back through untrained neural network 1106. In at least one embodiment, training framework 1104 adjusts weights that control untrained neural network 1106. In at least one embodiment, training framework 1104 includes tools to monitor how well untrained neural network 1106 is converging towards a model, such as trained neural network 1108, suitable to generating correct answers, such as in result 1114, based on input data such as a new dataset 1112. In at least one embodiment, training framework 1104 trains untrained neural network 1106 repeatedly while adjust weights to refine an output of untrained neural network 1106 using a loss function and adjustment algorithm, such as stochastic gradient descent. In at least one embodiment, training framework 1104 trains untrained neural network 1106 until untrained neural network 1106 achieves a desired accuracy. In at least one embodiment, trained neural network 1108 can then be deployed to implement any number of machine learning operations.

In at least one embodiment, untrained neural network 1106 is trained using unsupervised learning, wherein untrained neural network 1106 attempts to train itself using unlabeled data. In at least one embodiment, unsupervised learning training dataset 1102 will include input data without any associated output data or “ground truth” data. In at least one embodiment, untrained neural network 1106 can learn groupings within training dataset 1102 and can determine how individual inputs are related to untrained dataset 1102. In at least one embodiment, unsupervised training can be used to generate a self-organizing map in trained neural network 1108 capable of performing operations useful in reducing dimensionality of new dataset 1112. In at least one embodiment, unsupervised training can also be used to perform anomaly detection, which allows identification of data points in new dataset 1112 that deviate from normal patterns of new dataset 1112.

In at least one embodiment, semi-supervised learning may be used, which is a technique in which in training dataset 1102 includes a mix of labeled and unlabeled data. In at least one embodiment, training framework 1104 may be used to perform incremental learning, such as through transferred learning techniques. In at least one embodiment, incremental learning enables trained neural network 1108 to adapt to new dataset 1112 without forgetting knowledge instilled within trained neural network 1108 during initial training.

### Data Center

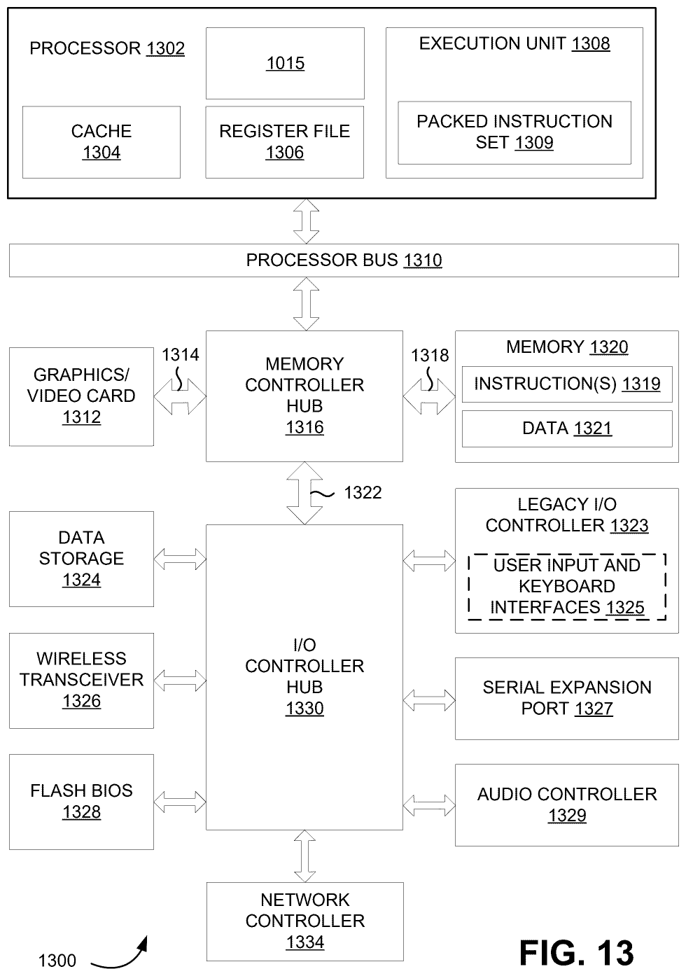

FIG. 12 illustrates an example data center 1200, in which at least one embodiment may be used. In at least one embodiment, data center 1200 includes a data center infrastructure layer 1210, a framework layer 1220, a software layer 1230, and an application layer 1240.

In at least one embodiment, as shown in FIG. 12, data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (“CPUs”) or other processors (including accelerators, field programmable gate arrays (FPGAs), data processing units, graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 1216(1)-1216(N) may be a server having one or more of above-mentioned computing resources.

In at least one embodiment, grouped computing resources 1214 may include separate groupings of node C.R.s housed within one or more racks (not shown), or many racks housed in data centers at various geographical locations (also not shown). Separate groupings of node C.R.s within grouped computing resources 1214 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 1212 may configure or otherwise control one or more node C.R.s 1216(1)-1216(N) and/or grouped computing resources 1214. In at least one embodiment, resource orchestrator 1212 may include a software design infrastructure (“SDI”) management entity for data center 1200. In at least one embodiment, resource orchestrator may include hardware, software or some combination thereof.

In at least one embodiment, as shown in FIG. 12, framework layer 1220 includes a job scheduler 1222, a configuration manager 1224, a resource manager 1226 and a distributed file system 1228. In at least one embodiment, framework layer 1220 may include a framework to support software 1232 of software layer 1230 and/or one or more application(s) 1242 of application layer 1240. In at least one embodiment, software 1232 or application(s) 1242 may respectively include web-based service software or applications, such as those provided by Amazon Web Services, Google Cloud and Microsoft Azure. In at least one embodiment, framework layer 1220 may be, but is not limited to, a type of free and open-source software web application framework such as Apache Spark™ (hereinafter “Spark”) that may utilize distributed file system 1228 for large-scale data processing (e.g., “big data”). In at least one embodiment, job scheduler 1222 may include a Spark driver to facilitate scheduling of workloads supported by various layers of data center 1200. In at least one embodiment, configuration manager 1224 may be capable of configuring different layers such as software layer 1230 and framework layer 1220 including Spark and distributed file system 1228 for supporting large-scale data processing. In at least one embodiment, resource manager 1226 may be capable of managing clustered or grouped computing resources mapped to or allocated for support of distributed file system 1228 and job scheduler 1222. In at least one embodiment, clustered or grouped computing resources may include grouped computing resource 1214 at data center infrastructure layer 1210. In at least one embodiment, resource manager 1226 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1228 of framework layer 1220. The one or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1228 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 1224, resource manager 1226, and resource orchestrator 1212 may implement any number and type of self-modifying actions based on any amount and type of data acquired in any technically feasible fashion. In at least one embodiment, self-modifying actions may relieve a data center operator of data center 1200 from making possibly bad configuration decisions and possibly avoiding underutilized and/or poor performing portions of a data center.

In at least one embodiment, data center 1200 may include tools, services, software, or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 1200. In at least one embodiment, trained machine learning models corresponding to one or more neural networks may be used to infer or predict information using resources described above with respect to data center 1200 by using weight parameters calculated through one or more training techniques described herein.

In at least one embodiment, data center may use CPUs, application-specific integrated circuits (ASICs), GPUs, DPUs FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 1015 are used to perform inferencing and/or training operations associated with one or more embodiments. Details regarding inference and/or training logic 1015 are provided below in conjunction with FIGS. 10A and/or 10B. In at least one embodiment, inference and/or training logic 1015 may be used in system FIG. 12 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

### Computer Systems

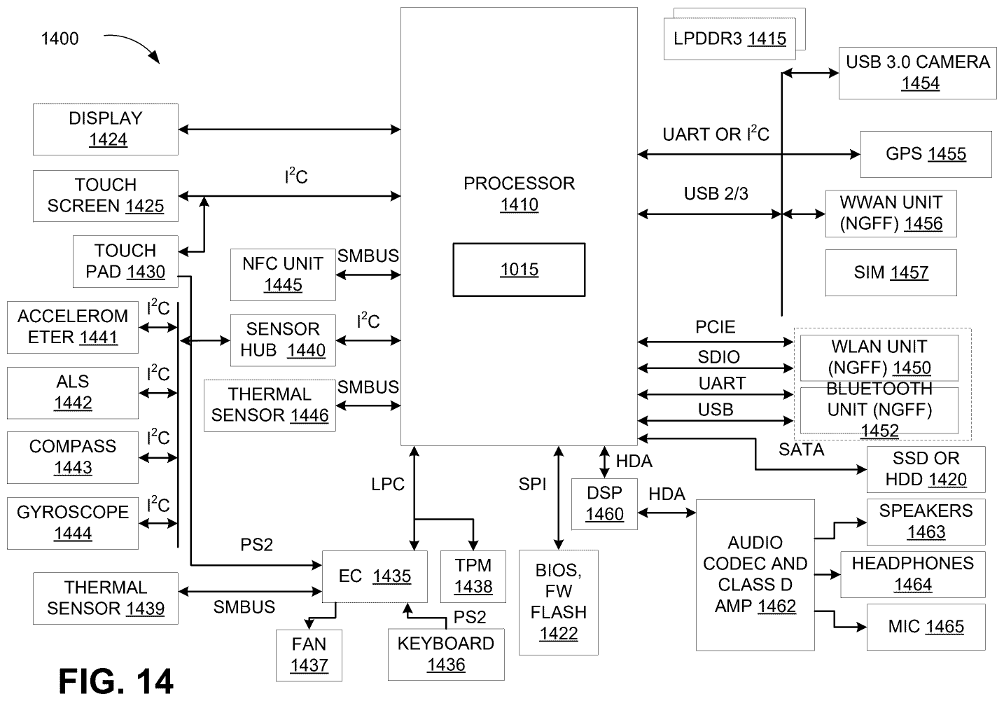

FIG. 13 is a block diagram illustrating an exemplary computer system, which may be a system with interconnected devices and components, a system-on-a-chip (SOC) or some combination thereof formed with a processor that may include execution units to execute an instruction, according to at least one embodiment. In at least one embodiment, a computer system 500 may include, without limitation, a component, such as a processor 502 to employ execution units including logic to perform algorithms for process data, in accordance with present disclosure, such as in embodiment described herein. In at least one embodiment, computer system 500 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 500 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 500 may include, without limitation, processor 502 that may include, without limitation, one or more execution units 508 to perform machine learning model training and/or inferencing according to techniques described herein. In at least one embodiment, computer system 500 is a single processor desktop or server system, but in another embodiment, computer system 500 may be a multiprocessor system. In at least one embodiment, processor 502 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 502 may be coupled to a processor bus 510 that may transmit data signals between processor 502 and other components in computer system 500.

In at least one embodiment, processor 502 may include, without limitation, a Level 1 (“L1”) internal cache memory (“cache”) 504. In at least one embodiment, processor 502 may have a single internal cache or multiple levels of internal cache. In at least one embodiment, cache memory may reside external to processor 502. Other embodiments may also include a combination of both internal and external caches depending on particular implementation and needs. In at least one embodiment, a register file 506 may store different types of data in various registers including, without limitation, integer registers, floating point registers, status registers, and an instruction pointer register.

In at least one embodiment, execution unit 508, including, without limitation, logic to perform integer and floating point operations, also resides in processor 502. In at least one embodiment, processor 502 may also include a microcode (“ucode”) read only memory (“ROM”) that stores microcode for certain macro instructions. In at least one embodiment, execution unit 508 may include logic to handle a packed instruction set 509. In at least one embodiment, by including packed instruction set 509 in an instruction set of a general-purpose processor, along with associated circuitry to execute instructions, operations used by many multimedia applications may be performed using packed data in processor 502. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, execution unit 508 may also be used in microcontrollers, embedded processors, graphics devices, DSPs, and other types of logic circuits. In at least one embodiment, computer system 1300 may include, without limitation, a memory 1320. In at least one embodiment, memory 1320 may be a Dynamic Random Access Memory (“DRAM”) device, a Static Random Access Memory (“SRAM”) device, a flash memory device, or another memory device. In at least one embodiment, memory 1320 may store instruction(s) 1319 and/or data 1321 represented by data signals that may be executed by processor 1302.

In at least one embodiment, a system logic chip may be coupled to processor bus 1310 and memory 1320. In at least one embodiment, a system logic chip may include, without limitation, a memory controller hub (“MCH”) 1316, and processor 1302 may communicate with MCH 1316 via processor bus 1310. In at least one embodiment, MCH 1316 may provide a high bandwidth memory path 1318 to memory 1320 for instruction and data storage and for storage of graphics commands, data and textures. In at least one embodiment, MCH 1316 may direct data signals between processor 1302, memory 1320, and other components in computer system 1300 and to bridge data signals between processor bus 1310, memory 1320, and a system I/O interface 1322. In at least one embodiment, a system logic chip may provide a graphics port for coupling to a graphics controller. In at least one embodiment, MCH 1316 may be coupled to memory 1320 through high bandwidth memory path 1318 and a graphics/video card 1312 may be coupled to MCH 1316 through an Accelerated Graphics Port (“AGP”) interconnect 1314.

In at least one embodiment, computer system 1300 may use system I/O interface 1322 as a proprietary hub interface bus to couple MCH 1316 to an I/O controller hub (“ICH”) 1330. In at least one embodiment, ICH 1330 may provide direct connections to some I/O devices via a local I/O bus. In at least one embodiment, a local I/O bus may include, without limitation, a high-speed I/O bus for connecting peripherals to memory 1320, a chipset, and processor 1302. Examples may include, without limitation, an audio controller 1329, a firmware hub (“flash BIOS”) 1328, a wireless transceiver 1326, a data storage 1324, a legacy I/O controller 1323 containing user input and keyboard interfaces 1325, a serial expansion port 1327, such as a Universal Serial Bus (“USB”) port, and a network controller 1334. In at least one embodiment, data storage 1324 may comprise a hard disk drive, a floppy disk drive, a CD-ROM device, a flash memory device, or other mass storage device.

In at least one embodiment, FIG. 13 illustrates a system, which includes interconnected hardware devices or “chips”, whereas in other embodiments, FIG. 13 may illustrate an exemplary SoC. In at least one embodiment, devices illustrated in FIG. 13 may be interconnected with proprietary interconnects, standardized interconnects (e.g., PCIe) or some combination thereof. In at least one embodiment, one or more components of computer system 1300 are interconnected using compute express link (CXL) interconnects.

Inference and/or training logic 1015 are used to perform inferencing and/or training operations associated with one or more embodiments. Details regarding inference and/or training logic 1015 are provided herein in conjunction with FIGS. 10A and/or 10B. In at least one embodiment, inference and/or training logic 1015 may be used in system FIG. 13 for inferencing or predicting operations based, at least in part, on weight parameters calculated using neural network training operations, neural network functions and/or architectures, or neural network use cases described herein.

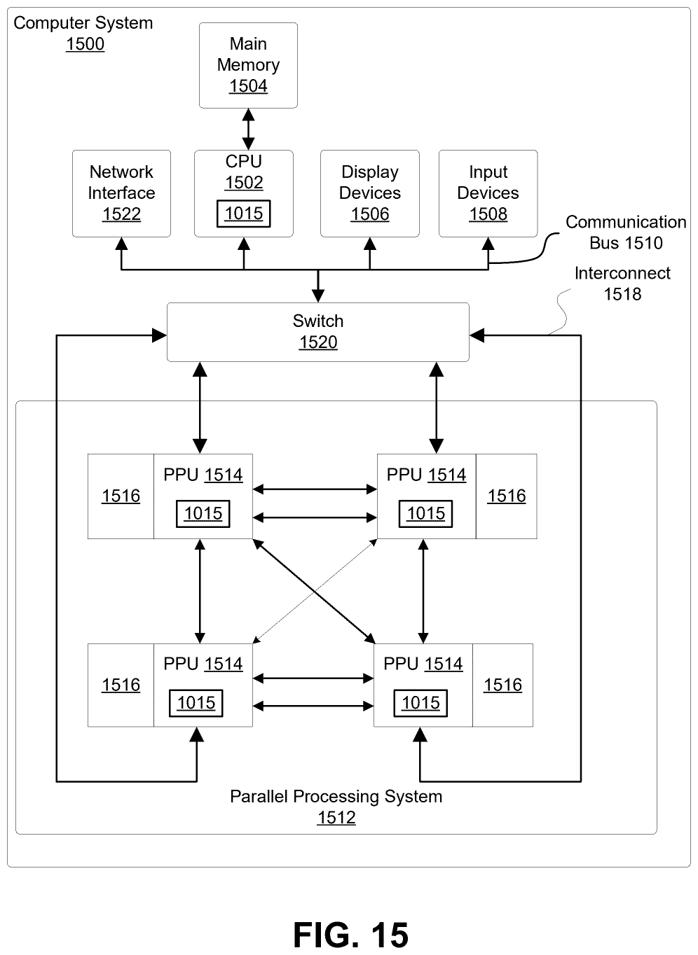

FIG. 14 is a block diagram illustrating an electronic device 1400 for utilizing a processor 1410, according to at least one embodiment. In at least one embodiment, electronic device 1400 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 1400 may include, without limitation, processor 1410 communicatively coupled to any suitable number or kind of components, peripherals, modules, or devices. In at least one embodiment, processor 1410 is coupled using a bus or interface, such as a I2C bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3, etc.), or a Universal Asynchronous Receiver/Transmitter (“UART”) bus. In at least one embodiment, FIG. 14 illustrates a system, which includes interconnected hardware devices or “chips”, whereas in other embodiments, FIG. 14 may illustrate an exemplary SoC. In at least one embodiment, devices illustrated in FIG. 14 may be interconnected with proprietary interconnects, standardized interconnects (e.g., PCIe) or some combination thereof. In at least one embodiment, one or more components of FIG. 14 are interconnected using compute express link (CXL) interconnects.

In at least one embodiment, FIG. 14 may include a display 1424, a touch screen 1425, a touch pad 1430, a Near Field Communications unit (“NFC”) 1445, a sensor hub 1440, a thermal sensor 1446, an Express Chipset (“EC”) 1435, a Trusted Platform Module (“TPM”) 1438, BIOS/firmware/flash memory (“BIOS, FW Flash”) 1422, a DSP 1460, a drive 1420 such as a Solid State Disk (“SSD”) or a Hard Disk Drive (“HDD”), a wireless local area network unit (“WLAN”) 1450, a Bluetooth unit 1452, a Wireless Wide Area Network unit (“WWAN”) 1456, a Global Positioning System (GPS) unit 1455, a camera (“USB 3.0 camera”) 1454 such as a USB 3.0 camera, and/or a Low Power Double Data Rate (“LPDDR”) memory unit (“LPDDR3”) 1415 implemented in, for example, an LPDDR3 standard. These components may each be implemented in any suitable manner.

In at least one embodiment, other components may be communicatively coupled to processor 1410 through components described herein. In at least one embodiment, an accelerometer 1441, an ambient light sensor (“ALS”) 1442, a compass 1443, and a gyroscope 1444 may be communicatively coupled to sensor hub 1440. In at least one embodiment, a thermal sensor 1439, a fan 1437, a keyboard 1436, and touch pad 1430 may be communicatively coupled to EC 1435. In at least one embodiment, speakers 1463, headphones 1464, and a microphone (“mic”) 1465 may be communicatively coupled to an audio unit (“audio codec and class D amp”) 1462, which may in turn be communicatively coupled to DSP 1460. In at least one embodiment, audio unit 1462 may include, for example and without limitation, an audio coder/decoder (“codec”) and a class D amplifier. In at least one embodiment, a SIM card (“SIM”) 1457 may be communicatively coupled to WWAN unit 1456. In at least one embodiment, components such as WLAN unit 1450 and Bluetooth unit 1452, as well as WWAN unit 1456 may be implemented in a Next Generation Form Factor (“NGFF”).

Inference and/or training logic 1015 are used to perform inferencing and/or training operations associated with one or more embodiments. Details regarding inference and/or training logic 1015 are provided herein in conjunction with FIGS. 10A and/or 10B. In at least one embodiment, inference and/or training logic 1015 may be used in system FIG. 14 for inferencing or predicting operations based, at least in part, on weight parameters calculated using neural network training operations, neural network functions and/or architectures, or neural network use cases described herein.

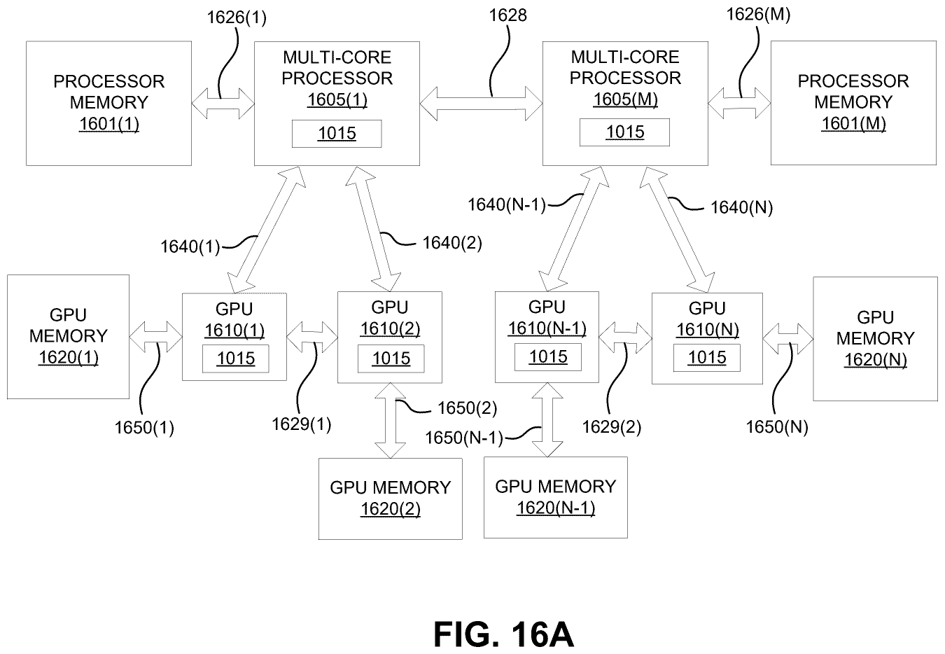

FIG. 15 illustrates a computer system 1500, according to at least one embodiment. In at least one embodiment, computer system 1500 is configured to implement various processes and methods described throughout this disclosure.

In at least one embodiment, computer system 1500 comprises, without limitation, at least one central processing unit (“CPU”) 1502 that is connected to a communication bus 1510 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 1500 includes, without limitation, a main memory 1504 and control logic (e.g., implemented as hardware, software, or a combination thereof) and data are stored in main memory 1504, which may take form of random access memory (“RAM”). In at least one embodiment, a network interface subsystem (“network interface”) 1522 provides an interface to other computing devices and networks for receiving data from and transmitting data to other systems with computer system 1500.

In at least one embodiment, computer system 1500, in at least one embodiment, includes, without limitation, input devices 1508, a parallel processing system 1512, and display devices 1506 that can be implemented using a conventional cathode ray tube (“CRT”), a liquid crystal display (“LCD”), a light emitting diode (“LED”) display, a plasma display, or other suitable display technologies. In at least one embodiment, user input is received from input devices 1508 such as keyboard, mouse, touchpad, microphone, etc. In at least one embodiment, each module described herein can be situated on a single semiconductor platform to form a processing system.

Inference and/or training logic 1015 are used to perform inferencing and/or training operations associated with one or more embodiments. Details regarding inference and/or training logic 1015 are provided herein in conjunction with FIGS. 10A and/or 10B. In at least one embodiment, inference and/or training logic 1015 may be used in system FIG. 15 for inferencing or predicting operations based, at least in part, on weight parameters calculated using neural network training operations, neural network functions and/or architectures, or neural network use cases described herein.

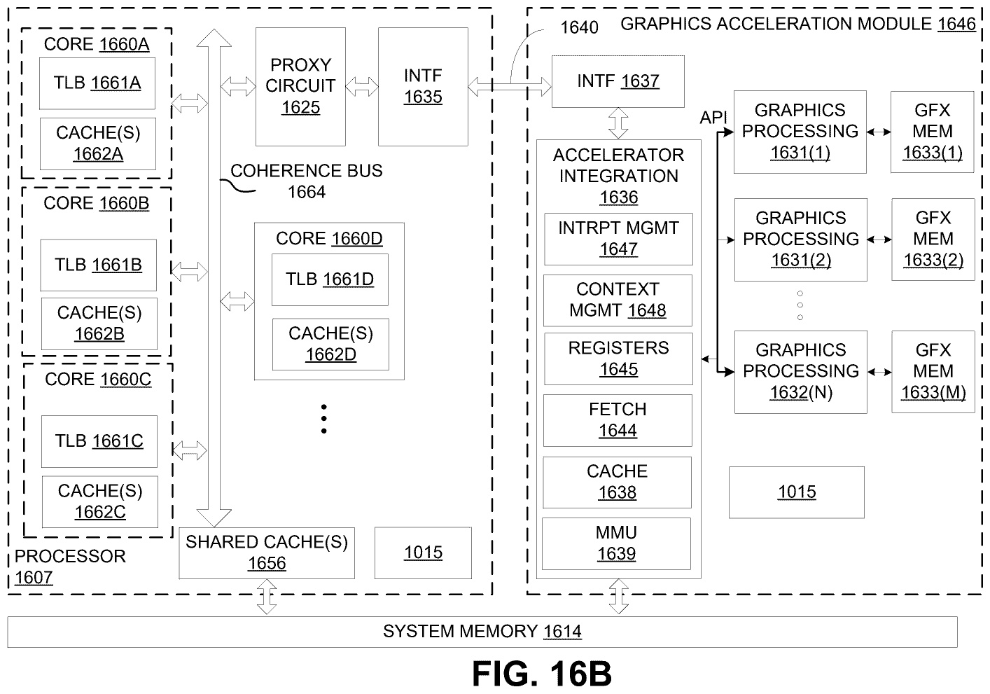

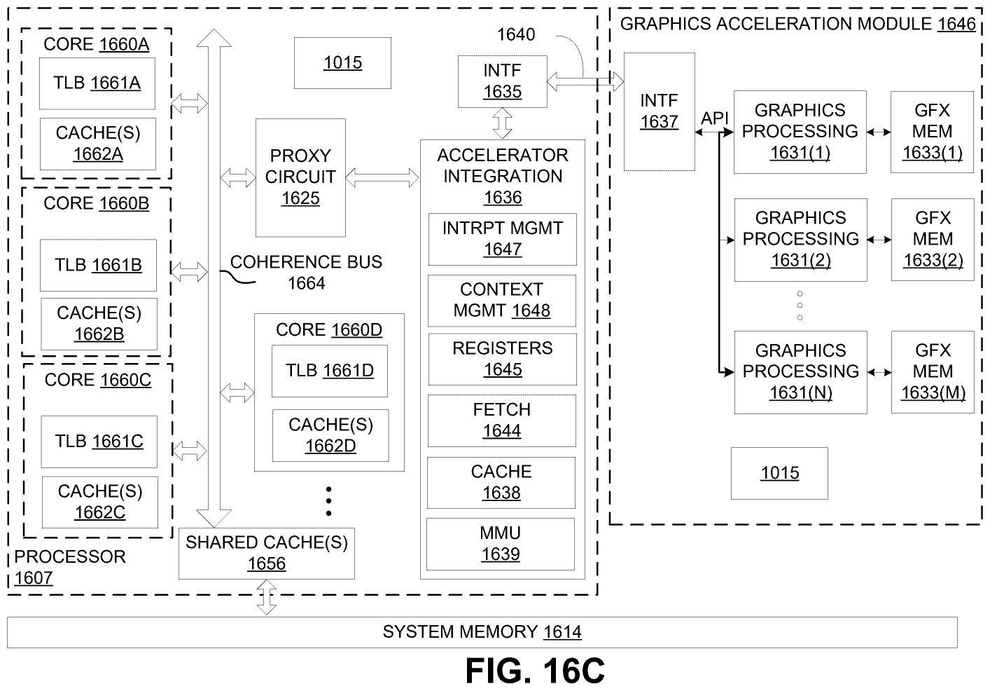

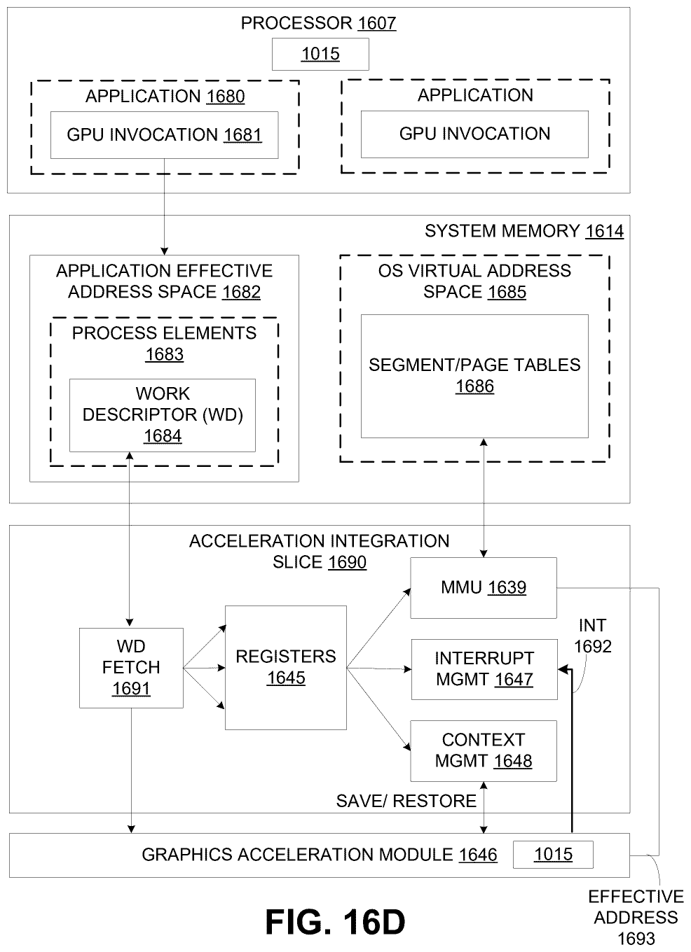

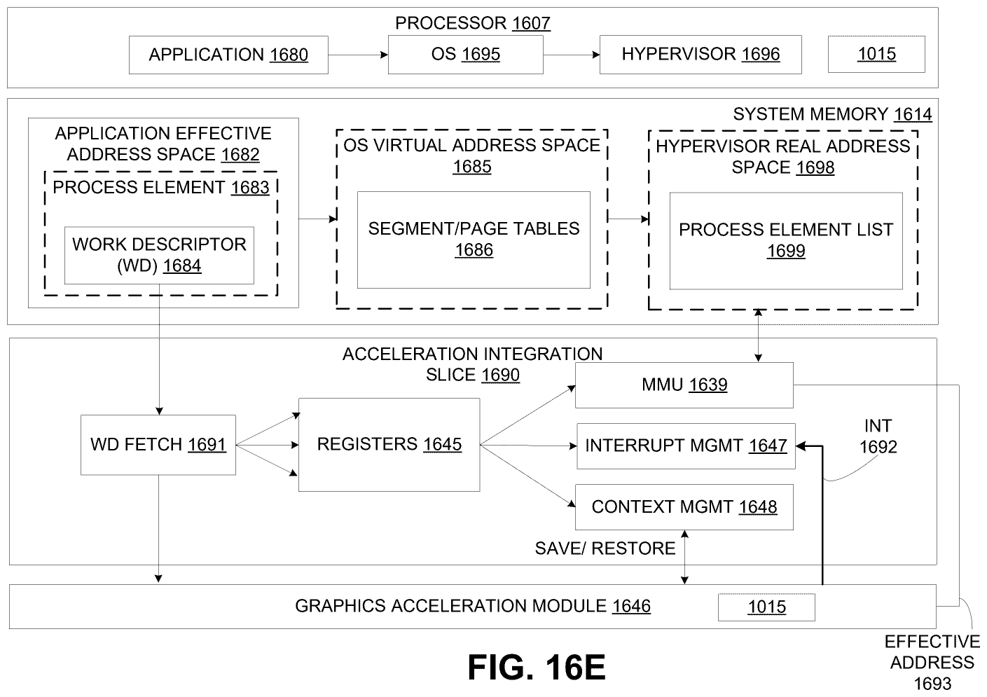

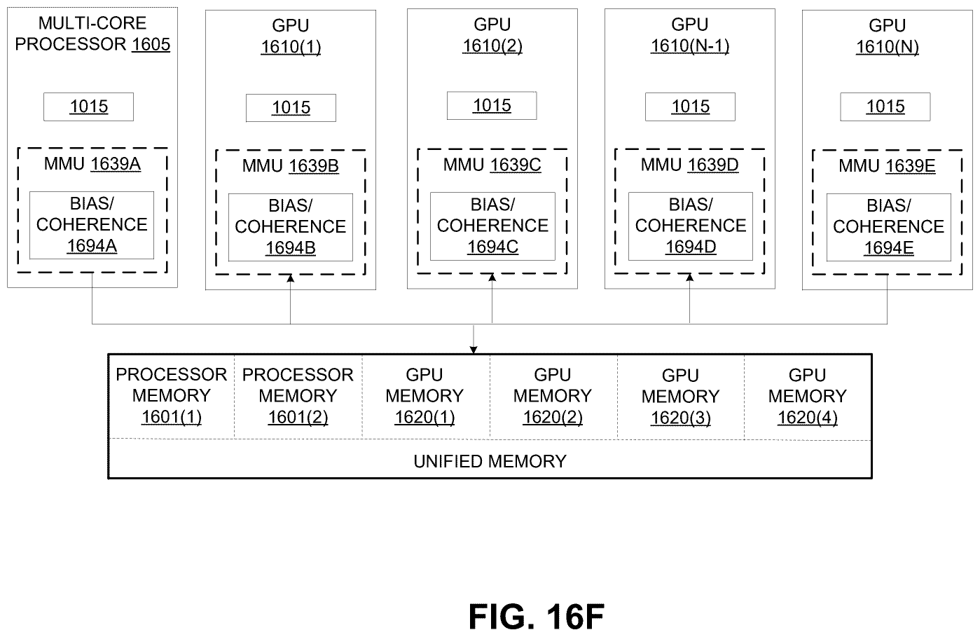

FIG. 16A illustrates an exemplary architecture in which a plurality of GPUs 1610(1)-1610(N) is communicatively coupled to a plurality of multi-core processors 1605(1)-1605(M) over high-speed links 1640(1)-1640(N) (e.g., buses, point-to-point interconnects, etc.). In at least one embodiment, high-speed links 1640(1)-1640(N) support a communication throughput of 4 GB/s, 30 GB/s, 80 GB/s or higher. In at least one embodiment, various interconnect protocols may be used including, but not limited to, PCIe 4.0 or 5.0 and NVLink 2.0. In various figures, “N” and “M” represent positive integers, values of which may be different from figure to figure.

In addition, and in at least one embodiment, two or more of GPUs 1610 are interconnected over high-speed links 1629(1)-1629(2), which may be implemented using similar or different protocols/links than those used for high-speed links 1640(1)-1640(N). Similarly, two or more of multi-core processors 1605 may be connected over a high-speed link 1628 which may be symmetric multi-processor (SMP) buses operating at 20 GB/s, 30 GB/s, 120 GB/s or higher. Alternatively, all communication between various system components shown in FIG. 16A may be accomplished using similar protocols/links (e.g., over a common interconnection fabric).

In at least one embodiment, each multi-core processor 1605 is communicatively coupled to a processor memory 1601(1)-1601(M), via memory interconnects 1626(1)-1626(M), respectively, and each GPU 1610(1)-1610(N) is communicatively coupled to GPU memory 1620(1)-1620(N) over GPU memory interconnects 1650(1)-1650(N), respectively. In at least one embodiment, memory interconnects 1626 and 1650 may utilize similar or different memory access technologies. By way of example, and not limitation, processor memories 1601(1)-1601(M) and GPU memories 1620 may be volatile memories such as dynamic random access memories (DRAMs) (including stacked DRAMs), Graphics DDR SDRAM (GDDR) (e.g., GDDR5, GDDR6), or High Bandwidth Memory (HBM) and/or may be non-volatile memories such as 3D XPoint or Nano-Ram. In at least one embodiment, some portion of processor memories 1601 may be volatile memory and another portion may be non-volatile memory (e.g., using a two-level memory (2LM) hierarchy).

As described herein, although various multi-core processors 1605 and GPUs 1610 may be physically coupled to a particular memory 1601, 1620, respectively, and/or a unified memory architecture may be implemented in which a virtual system address space (also referred to as “effective address” space) is distributed among various physical memories. For example, processor memories 1601(1)-1601(M) may each comprise 64 GB of system memory address space and GPU memories 1620(1)-1620(N) may each comprise 32 GB of system memory address space resulting in a total of 256 GB addressable memory when M=2 and N=4. Other values for N and M are possible.

FIG. 16B illustrates additional details for an interconnection between a multi-core processor 1607 and a graphics acceleration module 1646 in accordance with one exemplary embodiment. In at least one embodiment, graphics acceleration module 1646 may include one or more GPU chips integrated on a line card which is coupled to processor 1607 via high-speed link 1640 (e.g., a PCIe bus, NVLink, etc.). In at least one embodiment, graphics acceleration module 1646 may alternatively be integrated on a package or chip with processor 1607.

In at least one embodiment, processor 1607 includes a plurality of cores 1660A-1660D, each with a translation lookaside buffer (“TLB”) 1661A-1661D and one or more caches 1662A-1662D. In at least one embodiment, cores 1660A-1660D may include various other components for executing instructions and processing data that are not illustrated. In at least one embodiment, caches 1662A-1662D may comprise Level 1 (L1) and Level 2 (L2) caches. In addition, one or more shared caches 1656 may be included in caches 1662A-1662D and shared by sets of cores 1660A-1660D. For example, one embodiment of processor 1607 includes 24 cores, each with its own L1 cache, twelve shared L2 caches, and twelve shared L3 caches. In this embodiment, one or more L2 and L3 caches are shared by two adjacent cores. In at least one embodiment, processor 1607 and graphics acceleration module 1646 connect with system memory 1614, which may include processor memories 1601(1)-1601(M) of FIG. 16A.

In at least one embodiment, coherency is maintained for data and instructions stored in various caches 1662A-1662D, 1656 and system memory 1614 via inter-core communication over a coherence bus 1664. In at least one embodiment, for example, each cache may have cache coherency logic/circuitry associated therewith to communicate to over coherence bus 1664 in response to detected reads or writes to particular cache lines. In at least one embodiment, a cache snooping protocol is implemented over coherence bus 1664 to snoop cache accesses.

In at least one embodiment, a proxy circuit 1625 communicatively couples graphics acceleration module 1646 to coherence bus 1664, allowing graphics acceleration module 1646 to participate in a cache coherence protocol as a peer of cores 1660A-1660D. In particular, in at least one embodiment, an interface 1635 provides connectivity to proxy circuit 1625 over high-speed link 1640 and an interface 1637 connects graphics acceleration module 1646 to high-speed link 1640.

In at least one embodiment, an accelerator integration circuit 1636 provides cache management, memory access, context management, and interrupt management services on behalf of a plurality of graphics processing engines 1631(1)-1631(N) of graphics acceleration module 1646. In at least one embodiment, graphics processing engines 1631(1)-1631(N) may each comprise a separate graphics processing unit (GPU). In at least one embodiment, graphics processing engines 1631(1)-1631(N) alternatively may comprise different types of graphics processing engines within a GPU, such as graphics execution units, media processing engines (e.g., video encoders/decoders), samplers, and blit engines. In at least one embodiment, graphics acceleration module 1646 may be a GPU with a plurality of graphics processing engines 1631(1)-1631(N) or graphics processing engines 1631(1)-1631(N) may be individual GPUs integrated on a common package, line card, or chip.

In at least one embodiment, accelerator integration circuit 1636 includes a memory management unit (MMU) 1639 for performing various memory management functions such as virtual-to-physical memory translations (also referred to as effective-to-real memory translations) and memory access protocols for accessing system memory 1614. In at least one embodiment, MMU 1639 may also include a translation lookaside buffer (TLB) (not shown) for caching virtual/effective to physical/real address translations. In at least one embodiment, a cache 1638 can store commands and data for efficient access by graphics processing engines 1631(1)-1631(N). In at least one embodiment, data stored in cache 1638 and graphics memories 1633(1)-1633(M) is kept coherent with core caches 1662A-1662D, 1656 and system memory 1614, possibly using a fetch unit 1644. As mentioned, this may be accomplished via proxy circuit 1625 on behalf of cache 1638 and memories 1633(1)-1633(M) (e.g., sending updates to cache 1638 related to modifications/accesses of cache lines on processor caches 1662A-1662D, 1656 and receiving updates from cache 1638).

In at least one embodiment, a set of registers 1645 store context data for threads executed by graphics processing engines 1631(1)-1631(N) and a context management circuit 1648 manages thread contexts. For example, context management circuit 1648 may perform save and restore operations to save and restore contexts of various threads during contexts switches (e.g., where a first thread is saved and a second thread is stored so that a second thread can be execute by a graphics processing engine). For example, on a context switch, context management circuit 1648 may store current register values to a designated region in memory (e.g., identified by a context pointer). It may then restore register values when returning to a context. In at least one embodiment, an interrupt management circuit 1647 receives and processes interrupts received from system devices.

In at least one embodiment, virtual/effective addresses from a graphics processing engine 1631 are translated to real/physical addresses in system memory 1614 by MMU 1639. In at least one embodiment, accelerator integration circuit 1636 supports multiple (e.g., 4, 8, 16) graphics accelerator modules 1646 and/or other accelerator devices. In at least one embodiment, graphics accelerator module 1646 may be dedicated to a single application executed on processor 1607 or may be shared between multiple applications. In at least one embodiment, a virtualized graphics execution environment is presented in which resources of graphics processing engines 1631(1)-1631(N) are shared with multiple applications or virtual machines (VMs). In at least one embodiment, resources may be subdivided into “slices” which are allocated to different VMs and/or applications based on processing requirements and priorities associated with VMs and/or applications.

In at least one embodiment, accelerator integration circuit 1636 performs as a bridge to a system for graphics acceleration module 1646 and provides address translation and system memory cache services. In addition, in at least one embodiment, accelerator integration circuit 1636 may provide virtualization facilities for a host processor to manage virtualization of graphics processing engines 1631(1)-1631(N), interrupts, and memory management.

In at least one embodiment, because hardware resources of graphics processing engines 1631(1)-1631(N) are mapped explicitly to a real address space seen by host processor 1607, any host processor can address these resources directly using an effective address value. In at least one embodiment, one function of accelerator integration circuit 1636 is physical separation of graphics processing engines 1631(1)-1631(N) so that they appear to a system as independent units.

In at least one embodiment, one or more graphics memories 1633(1)-1633(M) are coupled to each of graphics processing engines 1631(1)-1631(N), respectively and N=M. In at least one embodiment, graphics memories 1633(1)-1633(M) store instructions and data being processed by each of graphics processing engines 1631(1)-1631(N). In at least one embodiment, graphics memories 1633(1)-1633(M) may be volatile memories such as DRAMs (including stacked DRAMs), GDDR memory (e.g., GDDR5, GDDR6), or HBM, and/or may be non-volatile memories such as 3D XPoint or Nano-Ram.

In at least one embodiment, to reduce data traffic over high-speed link 1640, biasing techniques can be used to ensure that data stored in graphics memories 1633(1)-1633(M) is data that will be used most frequently by graphics processing engines 1631(1)-1631(N) and preferably not used by cores 1660A-1660D (at least not frequently). Similarly, in at least one embodiment, a biasing mechanism attempts to keep data needed by cores (and preferably not graphics processing engines 1631(1)-1631(N)) within caches 1662A-1662D, 1656 and system memory 1614.

FIG. 16C illustrates another exemplary embodiment in which accelerator integration circuit 1636 is integrated within processor 1607. In this embodiment, graphics processing engines 1631(1)-1631(N) communicate directly over high-speed link 1640 to accelerator integration circuit 1636 via interface 1637 and interface 1635 (which, again, may be any form of bus or interface protocol). In at least one embodiment, accelerator integration circuit 1636 may perform similar operations as those described with respect to FIG. 16B, but potentially at a higher throughput given its close proximity to coherence bus 1664 and caches 1662A-1662D, 1656. In at least one embodiment, an accelerator integration circuit supports different programming models including a dedicated-process programming model (no graphics acceleration module virtualization) and shared programming models (with virtualization), which may include programming models which are controlled by accelerator integration circuit 1636 and programming models which are controlled by graphics acceleration module 1646.

In at least one embodiment, graphics processing engines 1631(1)-1631(N) are dedicated to a single application or process under a single operating system. In at least one embodiment, a single application can funnel other application requests to graphics processing engines 1631(1)-1631(N), providing virtualization within a VM/partition.

In at least one embodiment, graphics processing engines 1631(1)-1631(N), may be shared by multiple VM/application partitions. In at least one embodiment, shared models may use a system hypervisor to virtualize graphics processing engines 1631(1)-1631(N) to allow access by each operating system. In at least one embodiment, for single-partition systems without a hypervisor, graphics processing engines 1631(1)-1631(N) are owned by an operating system. In at least one embodiment, an operating system can virtualize graphics processing engines 1631(1)-1631(N) to provide access to each process or application.

In at least one embodiment, graphics acceleration module 1646 or an individual graphics processing engine 1631(1)-1631(N) selects a process element using a process handle. In at least one embodiment, process elements are stored in system memory 1614 and are addressable using an effective address to real address translation technique described herein. In at least one embodiment, a process handle may be an implementation-specific value provided to a host process when registering its context with graphics processing engine 1631(1)-1631(N) (that is, calling system software to add a process element to a process element linked list). In at least one embodiment, a lower 16-bits of a process handle may be an offset of a process element within a process element linked list.

FIG. 16D illustrates an exemplary accelerator integration slice 1690. In at least one embodiment, a “slice” comprises a specified portion of processing resources of accelerator integration circuit 1636. In at least one embodiment, an application is effective address space 1682 within system memory 1614 stores process elements 1683. In at least one embodiment, process elements 1683 are stored in response to GPU invocations 1681 from applications 1680 executed on processor 1607. In at least one embodiment, a process element 1683 contains process state for corresponding application 1680. In at least one embodiment, a work descriptor (WD) 1684 contained in process element 1683 can be a single job requested by an application or may contain a pointer to a queue of jobs. In at least one embodiment, WD 1684 is a pointer to a job request queue in an application's effective address space 1682.

In at least one embodiment, graphics acceleration module 1646 and/or individual graphics processing engines 1631(1)-1631(N) can be shared by all or a subset of processes in a system. In at least one embodiment, an infrastructure for setting up process states and sending a WD 1684 to a graphics acceleration module 1646 to start a job in a virtualized environment may be included.

In at least one embodiment, a dedicated-process programming model is implementation-specific. In at least one embodiment, in this model, a single process owns graphics acceleration module 1646 or an individual graphics processing engine 1631. In at least one embodiment, when graphics acceleration module 1646 is owned by a single process, a hypervisor initializes accelerator integration circuit 1636 for an owning partition and an operating system initializes accelerator integration circuit 1636 for an owning process when graphics acceleration module 1646 is assigned.

In at least one embodiment, in operation, a WD fetch unit 1691 in accelerator integration slice 1690 fetches next WD 1684, which includes an indication of work to be done by one or more graphics processing engines of graphics acceleration module 1646. In at least one embodiment, data from WD 1684 may be stored in registers 1645 and used by MMU 1639, interrupt management circuit 1647 and/or context management circuit 1648 as illustrated. For example, one embodiment of MMU 1639 includes segment/page walk circuitry for accessing segment/page tables 1686 within an OS virtual address space 1685. In at least one embodiment, interrupt management circuit 1647 may process interrupt events 1692 received from graphics acceleration module 1646. In at least one embodiment, when performing graphics operations, an effective address 1693 generated by a graphics processing engine 1631(1)-1631(N) is translated to a real address by MMU 1639.

In at least one embodiment, registers 1645 are duplicated for each graphics processing engine 1631(1)-1631(N) and/or graphics acceleration module 1646 and may be initialized by a hypervisor or an operating system. In at least one embodiment, each of these duplicated registers may be included in an accelerator integration slice 1690. Exemplary registers that may be initialized by a hypervisor are shown in Table 1.

TABLE 1
Hypervisor Initialized Registers

| Register # | Description |
|---|---|
| 1 | Slice Control Register |
| 2 | Real Address (RA) Scheduled Processes Area Pointer |
| 3 | Authority Mask Override Register |
| 4 | Interrupt Vector Table Entry Offset |
| 5 | Interrupt Vector Table Entry Limit |
| 6 | State Register |
| 7 | Logical Partition ID |
| 8 | Real address (RA) Hypervisor Accelerator Utilization |
| | Record Pointer |
| 9 | Storage Description Register |

Exemplary registers that may be initialized by an operating system are shown in Table 2.

TABLE 2
Operating System Initialized Registers

| Register # | Description |
|---|---|
| 1 | Process and Thread Identification |
| 2 | Effective Address (EA) Context Save/Restore Pointer |
| 3 | Virtual Address (VA) Accelerator Utilization Record |
| | Pointer |
| 4 | Virtual Address (VA) Storage Segment Table Pointer |
| 5 | Authority Mask |
| 6 | Work descriptor |

In at least one embodiment, each WD 1684 is specific to a particular graphics acceleration module 1646 and/or graphics processing engines 1631(1)-1631(N). In at least one embodiment, it contains all information required by a graphics processing engine 1631(1)-1631(N) to do work, or it can be a pointer to a memory location where an application has set up a command queue of work to be completed.

FIG. 16E illustrates additional details for one exemplary embodiment of a shared model. This embodiment includes a hypervisor real address space 1698 in which a process element list 1699 is stored. In at least one embodiment, hypervisor real address space 1698 is accessible via a hypervisor 1696 which virtualizes graphics acceleration module engines for operating system 1695.

In at least one embodiment, shared programming models allow for all or a subset of processes from all or a subset of partitions in a system to use a graphics acceleration module 1646. In at least one embodiment, there are two programming models where graphics acceleration module 1646 is shared by multiple processes and partitions, namely time-sliced shared and graphics directed shared.

In at least one embodiment, in this model, system hypervisor 1696 owns graphics acceleration module 1646 and makes its function available to all operating systems 1695. In at least one embodiment, for a graphics acceleration module 1646 to support virtualization by system hypervisor 1696, graphics acceleration module 1646 may adhere to certain requirements, such as (1) an application's job request must be autonomous (that is, state does not need to be maintained between jobs), or graphics acceleration module 1646 must provide a context save and restore mechanism, (2) an application's job request is guaranteed by graphics acceleration module 1646 to complete in a specified amount of time, including any translation faults, or graphics acceleration module 1646 provides an ability to preempt processing of a job, and (3) graphics acceleration module 1646 must be guaranteed fairness between processes when operating in a directed shared programming model.

In at least one embodiment, application 1680 is required to make an operating system 1695 system call with a graphics acceleration module type, a work descriptor (WD), an authority mask register (AMR) value, and a context save/restore area pointer (CSRP). In at least one embodiment, graphics acceleration module type describes a targeted acceleration function for a system call. In at least one embodiment, graphics acceleration module type may be a system-specific value. In at least one embodiment, WD is formatted specifically for graphics acceleration module 1646 and can be in a form of a graphics acceleration module 1646 command, an effective address pointer to a user-defined structure, an effective address pointer to a queue of commands, or any other data structure to describe work to be done by graphics acceleration module 1646.

In at least one embodiment, an AMR value is an AMR state to use for a current process. In at least one embodiment, a value passed to an operating system is similar to an application setting an AMR. In at least one embodiment, if accelerator integration circuit 1636 (not shown) and graphics acceleration module 1646 implementations do not support a User Authority Mask Override Register (UAMOR), an operating system may apply a current UAMOR value to an AMR value before passing an AMR in a hypervisor call. In at least one embodiment, hypervisor 1696 may optionally apply a current Authority Mask Override Register (AMOR) value before placing an AMR into process element 1683. In at least one embodiment, CSRP is one of registers 1645 containing an effective address of an area in an application's effective address space 1682 for graphics acceleration module 1646 to save and restore context state. In at least one embodiment, this pointer is optional if no state is required to be saved between jobs or when a job is preempted. In at least one embodiment, context save/restore area may be pinned system memory.

Upon receiving a system call, operating system 1695 may verify that application 1680 has registered and been given authority to use graphics acceleration module 1646. In at least one embodiment, operating system 1695 then calls hypervisor 1696 with information shown in Table 3.

TABLE 3
OS to Hypervisor Call Parameters

| Parameter # | Description |
|---|---|
| 1 | A work descriptor (WD) |
| 2 | An Authority Mask Register (AMR) value (potentially |
| | masked) |
| 3 | An effective address (EA) Context Save/Restore Area |
| | Pointer (CSRP) |
| 4 | A process ID (PID) and optional thread ID (TID) |
| 5 | A virtual address (VA) accelerator utilization record |
| | pointer (AURP) |
| 6 | Virtual address of storage segment table pointer (SSTP) |
| 7 | A logical interrupt service number (LISN) |

In at least one embodiment, upon receiving a hypervisor call, hypervisor 1696 verifies that operating system 1695 has registered and been given authority to use graphics acceleration module 1646. In at least one embodiment, hypervisor 1696 then puts process element 1683 into a process element linked list for a corresponding graphics acceleration module 1646 type. In at least one embodiment, a process element may include information shown in Table 4.

TABLE 4
Process Element Information

| Element # | Description |
|---|---|
| 1 | A work descriptor (WD) |
| 2 | An Authority Mask Register (AMR) value (potentially |
| | masked). |
| 3 | An effective address (EA) Context Save/Restore Area |
| | Pointer (CSRP) |
| 4 | A process ID (PID) and optional thread ID (TID) |
| 5 | A virtual address (VA) accelerator utilization record |
| | pointer (AURP) |
| 6 | Virtual address of storage segment table pointer (SSTP) |
| 7 | A logical interrupt service number (LISN) |
| 8 | Interrupt vector table, derived from hypervisor call |
| | parameters |
| 9 | A state register (SR) value |
| 10 | A logical partition ID (LPID) |
| 11 | A real address (RA) hypervisor accelerator utilization |
| | record pointer |
| 12 | Storage Descriptor Register (SDR) |

In at least one embodiment, hypervisor initializes a plurality of accelerator integration slice 1690 registers 1645.

As illustrated in FIG. 16F, in at least one embodiment, a unified memory is used, addressable via a common virtual memory address space used to access physical processor memories 1601(1)-1601(N) and GPU memories 1620(1)-1620(N). In this implementation, operations executed on GPUs 1610(1)-1610(N) utilize a same virtual/effective memory address space to access processor memories 1601(1)-1601(M) and vice versa, thereby simplifying programmability. In at least one embodiment, a first portion of a virtual/effective address space is allocated to processor memory 1601(1), a second portion to second processor memory 1601(N), a third portion to GPU memory 1620(1), and so on. In at least one embodiment, an entire virtual/effective memory space (sometimes referred to as an effective address space) is thereby distributed across each of processor memories 1601 and GPU memories 1620, allowing any processor or GPU to access any physical memory with a virtual address mapped to that memory.

In at least one embodiment, bias/coherence management circuitry 1694A-1694E within one or more of MMUs 1639A-1639E ensures cache coherence between caches of one or more host processors (e.g., 1605) and GPUs 1610 and implements biasing techniques indicating physical memories in which certain types of data should be stored. In at least one embodiment, while multiple instances of bias/coherence management circuitry 1694A-1694E are illustrated in FIG. 16F, bias/coherence circuitry may be implemented within an MMU of one or more host processors 1605 and/or within accelerator integration circuit 1636.

One embodiment allows GPU memories 1620 to be mapped as part of system memory, and accessed using shared virtual memory (SVM) technology, but without suffering performance drawbacks associated with full system cache coherence. In at least one embodiment, an ability for GPU memories 1620 to be accessed as system memory without onerous cache coherence overhead provides a beneficial operating environment for GPU offload. In at least one embodiment, this arrangement allows software of host processor 1605 to setup operands and access computation results, without overhead of tradition I/O DMA data copies. In at least one embodiment, such traditional copies involve driver calls, interrupts and memory mapped I/O (MMIO) accesses that are all inefficient relative to simple memory accesses. In at least one embodiment, an ability to access GPU memories 1620 without cache coherence overheads can be critical to execution time of an offloaded computation. In at least one embodiment, in cases with substantial streaming write memory traffic, for example, cache coherence overhead can significantly reduce an effective write bandwidth seen by a GPU 1610. In at least one embodiment, efficiency of operand setup, efficiency of results access, and efficiency of GPU computation may play a role in determining effectiveness of a GPU offload.

In at least one embodiment, selection of GPU bias and host processor bias is driven by a bias tracker data structure. In at least one embodiment, a bias table may be used, for example, which may be a page-granular structure (e.g., controlled at a granularity of a memory page) that includes 1 or 2 bits per GPU-attached memory page. In at least one embodiment, a bias table may be implemented in a stolen memory range of one or more GPU memories 1620, with or without a bias cache in a GPU 1610 (e.g., to cache frequently/recently used entries of a bias table). Alternatively, in at least one embodiment, an entire bias table may be maintained within a GPU.

In at least one embodiment, a bias table entry associated with each access to a GPU attached memory 1620 is accessed prior to actual access to a GPU memory, causing following operations. In at least one embodiment, local requests from a GPU 1610 that find their page in GPU bias are forwarded directly to a corresponding GPU memory 1620. In at least one embodiment, local requests from a GPU that find their page in host bias are forwarded to processor 1605 (e.g., over a high-speed link as described herein). In at least one embodiment, requests from processor 1605 that find a requested page in host processor bias complete a request like a normal memory read. Alternatively, requests directed to a GPU-biased page may be forwarded to a GPU 1610. In at least one embodiment, a GPU may then transition a page to a host processor bias if it is not currently using a page. In at least one embodiment, a bias state of a page can be changed either by a software-based mechanism, a hardware-assisted software-based mechanism, or, for a limited set of cases, a purely hardware-based mechanism.

In at least one embodiment, one mechanism for changing bias state employs an API call (e.g., OpenCL), which, in turn, calls a GPU's device driver which, in turn, sends a message (or enqueues a command descriptor) to a GPU directing it to change a bias state and, for some transitions, perform a cache flushing operation in a host. In at least one embodiment, a cache flushing operation is used for a transition from host processor 1605 bias to GPU bias, but is not for an opposite transition.

In at least one embodiment, cache coherency is maintained by temporarily rendering GPU-biased pages uncacheable by host processor 1605. In at least one embodiment, to access these pages, processor 1605 may request access from GPU 1610, which may or may not grant access right away. In at least one embodiment, thus, to reduce communication between processor 1605 and GPU 1610 it is beneficial to ensure that GPU-biased pages are those which are required by a GPU but not host processor 1605 and vice versa.

Hardware structure(s) 1015 are used to perform one or more embodiments. Details regarding a hardware structure(s) 1015 may be provided herein in conjunction with FIGS. 10A and/or 10B.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but may be more when so indicated either explicitly or by context. Further, unless stated otherwise or otherwise clear from context, phrase “based on” means “based at least in part on” and not “based solely on.”

Operations of processes described herein may be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data may be accomplished in a variety of ways such as by receiving data as a parameter of a function call or a call to an application programming interface. In some embodiments, process of obtaining, acquiring, receiving, or inputting analog or digital data may be accomplished by transferring data via a serial or parallel interface. In another embodiment, process of obtaining, acquiring, receiving, or inputting analog or digital data may be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data may be accomplished by transferring data as an input or output parameter of a function call, a parameter of an application programming interface or interprocess communication mechanism.

Although discussion above sets forth example embodiments of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
identifying a criticality level of an application of a plurality of applications associated with a medical device;
based on the criticality level, determining to execute the application in one of a plurality of environments, wherein each environment of the plurality of environments provides a corresponding level of isolation from other applications of the plurality of applications; and
assigning one or more computing resources to the application based on at least one of the criticality level or resource requirements of the application.

2. The method of claim 1, wherein a first environment of the plurality of environments comprises the application executing directly on an operating system, wherein a second environment of the plurality of environments comprises the application executing in a container, and wherein a third environment of the plurality of environments comprises the application executing in a virtual machine.

3. The method of claim 1, wherein computing resources comprise at least one of central processing unit (CPU) resources or graphics processing unit (GPU) resources, wherein the GPU resources comprise a multi-instance GPU.

4. The method of claim 1, wherein the resource requirements comprise at least one of compute resources, graphics resources, or display resources.

5. The method of claim 1, wherein the application comprises an artificial intelligence model.

6. The method of claim 1, wherein the corresponding level of isolation comprises one of partial isolation or full isolation.

7. The method of claim 1, further comprising:
responsive to determining that the application is a native application, identifying the one or more computing resources to assign to the application on a discrete GPU.

8. The method of claim 1, further comprising:
responsive to determining that the one of the plurality of environments satisfies a criterion, identifying the one or more computing resources to assign to the application on an integrated GPU.

9. The method of claim 1, further comprising:
responsive to determining that the application is a third-party application, deploying the application in a virtual machine.

10. The method of claim 1, further comprising:
responsive to determining that the application is not a third-party application, deploying the application on one of on bare metal or in a container.

11. The method of claim 1, wherein the plurality of applications executes concurrently, wherein at least a first application of the plurality of applications executes in a first environment of the plurality of environments and a second application of the plurality of applications executes in a second environment of the plurality of environments, wherein the first environment comprises executing the application on bare metal or in a container, and wherein the second environment comprises executing the application in a virtual machine.

12. A system comprising:
one or more processors to perform operations comprising:
identifying a criticality level of an application associated with a medical device;
based on the criticality level, determining an execution environment for the application from a plurality of execution environments, wherein each execution environment of the plurality of execution environments provides a corresponding degree of isolation from other applications executing on the same compute platform as the application; and
allocating one or more computing resources to the application based at least on the execution environment.

13. The system of claim 12, wherein a first execution environment of the plurality of execution environments comprises the application executing directly on an operating system, wherein a second execution environment of the plurality of execution environments comprises the application executing in a container, and wherein a third execution environment of the plurality of execution environments comprises the application executing in a virtual machine.

14. The system of claim 12, wherein computing resources comprise at least one of central processing unit (CPU) resources or graphics processing unit (GPU) resources, wherein the GPU resources comprise a multi-instance GPU, and wherein the resource requirements comprise at least one of compute resources, graphics resources, or display resources.

15. The system of claim 12, wherein the application comprises an artificial intelligence model.

16. The system of claim 12, wherein the operations further comprise:
responsive to determining that the application is a third-party application, deploying the application in a virtual machine; and
responsive to determining that the application is not a third-party application, deploying the application on one of on bare metal or in a container.

17. The system of claim 12, wherein the operations further comprise concurrently executing a plurality of applications, wherein at least a first application of the plurality of applications executes in a first execution environment of the plurality of execution environments and a second application of the plurality of applications executes in a second execution environment of the plurality of execution environments, wherein the first execution environment comprises executing the application on bare metal or in a container, and wherein the second execution environment comprises executing the application in a virtual machine.

18. One or more processors comprising processing circuitry to:
provide a plurality of execution environments, wherein each execution environment of the plurality of execution environments provides a distinct level of operational isolation;
deploy an application within a selected execution environment from the plurality of execution environments based on a criticality level of the application; and
provision one or more computing resources to the application based at least on the selected execution environment.

19. The one or more processors of claim 18, wherein a first execution environment of the plurality of execution environments comprises the application executing directly on an operating system, wherein a second execution environment of the plurality of execution environments comprises the application executing in a container, and wherein a third execution environment of the plurality of execution environments comprises the application executing in a virtual machine.

20. The one or more processors of claim 18, wherein the distinct level of operational isolation comprises one of partial isolation or full isolation.
